(19) United States
(12) Patent Application Publication
(10) Pub. No.: US 2023/0278136 A1
(43) Pub. Date: Sep. 7, 2023

(54) LASER BEAM IRRADIATION OPTICAL UNIT AND LASER MACHINING APPARATUS

(71) Applicant: Tamron Co., Ltd., Saitama (JP)

(72) Inventors: Kazunori KOMORI, Saitama (JP); Takashi SAKAMOTO, Saitama (JP); Masaki TAKEMOTO, Saitama (JP)

(73) Assignee: Tamron Co., Ltd., Saitama (JP)

(21) Appl. No.: 18/113,357

(22) Filed: Feb. 23, 2023

(30) Foreign Application Priority Data
Mar. 1, 2022 (JP) 2022-030574

(51) Int. Cl. B23K 26/06; B23K 26/073

(52) U.S. Cl. CPC B23K 26/0648; B23K 26/0734

(57) ABSTRACT

Adopted is a laser beam irradiation optical unit for forming a spot on an object to be machined and irradiating the object to be machined with a laser beam emitted from a laser oscillator to perform laser machining including an energy intensity distribution adjustment mechanism that adjusts an energy intensity distribution of the laser beam at the spot in an irradiation trajectory of the laser beam from the laser oscillator to the object to be machined, in which the energy intensity distribution adjustment mechanism adjusts the energy intensity distribution of the laser beam at the spot so as to be non-uniform.

### CROSS-REFERENCE TO RELATED APPLICATIONS

This application is based on and claims the benefit of priority from Japanese Patent Application No. 2022-030574, filed on Mar. 1, 2022, the entire contents of which are incorporated herein by reference.

### BACKGROUND OF THE INVENTION

### Technical Field

The present invention relates to a laser beam irradiation optical unit and a laser machining apparatus.

### Related Art

In recent years, laser beams have been widely used for machining various products. The laser beam condenses at one point and a workpiece is irradiated with the laser beam, thereby rapidly increasing a surface temperature of the workpiece and melting or evaporating an irradiated surface of the workpiece. A laser machining apparatus using this laser beam is an apparatus that performs machining such as cutting, drilling, or welding on the workpiece in this manner. Since the laser beam is focused at one point, precise and fine machining can be performed at a pinpoint. In addition, by using a laser beam with higher energy, a machining time can be shortened, and it is also possible to machine a workpiece with high hardness that is difficult to machine with a blade.

Here, a spot, which is a laser beam focused, having a circular image shape of the laser beam and an energy intensity distribution of a Gaussian shape or top-hat shape has been conventionally employed. However, in the conventional laser machining using a spot, there is a problem that a workpiece melted by a laser beam remains on a cut surface or a hole portion during cutting, melting, or drilling of the workpiece, and machining quality is deteriorated. Therefore, in recent years, laser machining has been proposed in which an image shape of a laser beam at a spot is formed into an annular shape so that a molten workpiece is appropriately blown off and does not remain on the cut surface or the hole portion.

For example, in the case of welding a molten zinc steel plate and a molten zinc steel plate, by forming an image shape of a laser beam in a spot into an annular shape, sputtering during melting is caused to blow off in a direction opposite to an incident side of the laser beam in the spot, and machining quality is improved. In addition, in the case of machining a highly reflective material such as aluminum or copper, by setting an image shape of a laser beam at a spot to an annular shape and a center portion of the annular shape, it is possible to melt the workpiece at the annular portion to reduce the reflectance and to cut and weld the workpiece at the annular central portion, thereby improving the machining quality.

Therefore, U.S. Pat. No. 9285593 discloses an optical system in which a function of shifting a phase of a laser beam is introduced into the optical system and a phase difference is provided in a part of a light flux of the laser beam, so that an image shape of the laser beam at a spot is annular and an energy intensity distribution of the annular laser beam is uniform.

However, in a case where an image shape of a laser beam at a spot is annular and an energy intensity distribution of the annular laser beam is uniform, when a movement speed of the spot of the laser beam at the time of laser machining is low, a molten workpiece does not remain on a cut surface or a hole portion by appropriately blowing off the molten workpiece. However, when the movement speed of the spot of the laser beam at the time of laser machining increases, there is a problem that the molten workpiece remains on the cut surface or the hole. As a result, there is a problem that a throughput of laser machining cannot be increased.

The present invention has been made in view of such circumstances. An object of the present invention is to provide a laser beam irradiation optical unit and a laser machining apparatus capable of obtaining an image shape and energy intensity distribution of a spot of a laser beam that does not remain on a cut surface or a hole portion by appropriately blowing off a molten workpiece even when the movement speed of the spot of the laser beam is fast.

### SUMMARY OF THE INVENTION

In order to solve the above-described problems, as a result of intensive research, the following laser beam irradiation optical unit and laser machining apparatus have been conceived.

A laser beam irradiation optical unit according to the present invention adopts a laser beam irradiation optical unit for forming a spot on an object to be machined and irradiating the object to be machined with a laser beam emitted from a laser oscillator to perform laser machining, the laser beam irradiation optical unit including: an energy intensity distribution adjustment mechanism that adjusts an energy intensity distribution of the laser beam at the spot in an irradiation trajectory of the laser beam from the laser oscillator to the object to be machined, in which the energy intensity distribution adjustment mechanism adjusts the energy intensity distribution of the laser beam at the spot so as to be non-uniform.

A laser machining apparatus according to the present invention adopts a laser machining apparatus obtained by accommodating the above-described laser beam irradiation optical unit in a laser machining head.

The laser beam irradiation optical unit according to the present invention can melt a workpiece in a front region of a spot with respect to a movement direction and appropriately blow off the metal of the workpiece melted in a rear region of the spot even when a movement speed of the spot of a laser beam is fast. This prevents the molten workpiece from remaining on a cut surface or a hole portion of the workpiece. In addition, a laser machining apparatus using the laser beam irradiation optical unit according to the present invention has excellent machining quality of laser machining and high throughput.

### BRIEF DESCRIPTION OF THE DRAWINGS

FIG. 1 is a cross-sectional view illustrating an arrangement configuration of optical elements of a laser beam irradiation optical unit and an approximate trajectory of a laser beam;

FIGS. 2A and 2B are schematic diagrams of an energy intensity distribution in a spot;

FIGS. 3A and 3B are cross-sectional views of the laser beam irradiation optical unit in a case where the energy intensity distribution of the laser beam is non-uniformly adjusted using a condensing lens;

FIGS. 4A and 4B are cross-sectional views of the laser beam irradiation optical unit in a case where the energy intensity distribution of the laser beam is non-uniformly adjusted using a collimating lens;

FIGS. 5A and 5B are cross-sectional views of the laser beam irradiation optical unit in a case where the energy intensity distribution of the laser beam is non-uniformly adjusted using a laser beam direction adjustment mechanism;

FIGS. 6A and 6B are schematic cross-sectional views of the laser beam direction adjustment mechanism;

FIG. 7 is a measurement result in a case where an angle of a tilt amount is 0° in Example 1;

FIG. 8 is a measurement result in a case where the angle of the tilt amount is 3° in Example 1;

FIG. 9 is a measurement result in a case where the angle of the tilt amount is 3° in Example 1;

FIG. 10 is an energy distribution in an image shape of a laser beam at a shift of 0.0 mm in Example 2;

FIG. 11 is an energy distribution in an image shape of a laser beam at a shift of 0.125 mm in Example 2;

FIG. 12 is an energy distribution in an image shape of a laser beam at a shift of 1.0 mm in Example 2;

FIG. 13 is an energy distribution in an image shape of a laser beam at a shift of 4.0 mm in Example 2;

FIG. 14 is an energy intensity distribution in a Y position direction at a position where an X position is 0 at a shift of 0.0 mm in Example 2;

FIG. 15 is an energy intensity distribution in the Y position direction at a position where the X position is 0 at a shift of 0.125 mm in Example 2;

FIG. 16 is an energy intensity distribution in the Y position direction at a position where the X position is 0 at a shift of 1.0 mm in Example 2;

FIG. 17 is an energy intensity distribution in the Y position direction at a position where the X position is 0 at a shift of 4.0 mm in Example 2;

FIG. 18 is an energy distribution in an image shape of a laser beam at a tilt of 0° in Example 3;

FIG. 19 is an energy distribution in an image shape of a laser beam at a tilt of 3′ in Example 3;

FIG. 20 is an energy distribution in an image shape of a laser beam at a tilt of 7° in Example 3;

FIG. 21 is an energy intensity distribution in a Y position direction at a position where an X position is 0 at a tilt of 0° in Example 3;

FIG. 22 is an energy intensity distribution in the Y position direction at a position where the X position is 0 at a tilt of 3° in Example 3;

FIG. 23 is an energy intensity distribution in the Y position direction at a position where the X position is 0 at a tilt of 7° in Example 3;

FIG. 24 is an energy distribution in an image shape of a laser beam at a shift of 0.0 mm in Example 4;

FIG. 25 is an energy distribution in an image shape of a laser beam at a shift of 0.125 mm in Example 4;

FIG. 26 is an energy distribution in an image shape of a laser beam at a shift of 1.0 mm in Example 4;

FIG. 27 is an energy distribution in an image shape of a laser beam at a shift of 4.0 mm in Example 4;

FIG. 28 is an energy intensity distribution in the Y position direction at a position where the X position is 0 at a shift of 0.0 mm in Example 4;

FIG. 29 is an energy intensity distribution in the Y position direction at a position where the X position is 0 at a shift of 0.125 mm in Example 4;

FIG. 30 is an energy intensity distribution in the Y position direction at a position where the X position is 0 at a shift of 1.0 mm in Example 4;

FIG. 31 is an energy intensity distribution in the Y position direction at a position where the X position is 0 at a shift of 4.0 mm in Example 4;

FIG. 32 is an energy distribution in an image shape of a laser beam at a tilt of 0° in Example 5;

FIG. 33 is an energy distribution in an image shape of a laser beam at a tilt of 1° in Example 5;

FIG. 34 is an energy distribution in an image shape of a laser beam at a tilt of 4° in Example 5;

FIG. 35 is an energy intensity distribution in a Y position direction at a position where an X position is 0 at a tilt of 0° in Example 5;

FIG. 36 is an energy intensity distribution in a Y position direction at a position where an X position is 0 at a tilt of 1° in Example 5;

FIG. 37 is an energy intensity distribution in the Y position direction at a position where the X position is 0 at a tilt of 4° in Example 5;

FIG. 38 is an energy distribution in an image shape of a laser beam at a shift of 0.0 mm in Example 6;

FIG. 39 is an energy distribution in an image shape of a laser beam at a shift of 0.125 mm in Example 6;

FIG. 40 is an energy distribution in an image shape of a laser beam at a shift of 4.0 mm in Example 6;

FIG. 41 is an energy intensity distribution in the Y position direction at a position where the X position is 0 at a shift of 0.0 mm in Example 6;

FIG. 42 is an energy intensity distribution in the Y position direction at a position where the X position is 0 at a shift of 0.125 mm in Example 6;

FIG. 43 is an energy intensity distribution in the Y position direction at a position where the X position is 0 at a shift of 4.0 mm in Example 6;

FIG. 44 is an energy distribution in an image shape of a laser beam at a tilt of 0° in Example 7;

FIG. 45 is an energy distribution in an image shape of a laser beam at a tilt of 3° in Example 7;

FIG. 46 is an energy distribution in an image shape of a laser beam at a tilt of 7° in Example 7;

FIG. 47 is an energy intensity distribution in a Y position direction at a position where an X position is 0 at a tilt of 0° in Example 7;

FIG. 48 is an energy intensity distribution in the Y position direction at a position where the X position is 0 at a tilt of 3° in Example 7; and

FIG. 49 is an energy intensity distribution in the Y position direction at a position where the X position is 0 at a tilt of 7° in Example 7.

### DESCRIPTION OF THE EMBODIMENTS

Hereinafter, embodiments of a laser beam irradiation optical unit and a laser machining apparatus according to the present invention will be described. Note that what will be described below merely illustrates one aspect, and is not to be construed as being limited to the following description.

### 1. Laser Beam Irradiation Optical Unit

A laser beam irradiation optical unit according to the present invention is a laser beam irradiation optical unit for forming a spot on an object to be machined and irradiating the object to be machined with a laser beam emitted from a laser oscillator to perform laser machining, the laser beam irradiation optical unit including: an energy intensity distribution adjustment mechanism that adjusts an energy intensity distribution of the laser beam at the spot in an irradiation trajectory of the laser beam from the laser oscillator to the object to be machined, in which the energy intensity distribution adjustment mechanism adjusts the energy intensity distribution of the laser beam at the spot so as to be non-uniform.

The energy intensity distribution adjustment mechanism according to the present invention is realized by using at least one of a laser beam direction adjustment mechanism, a collimating lens, and a condensing lens.

By making an energy intensity distribution of a laser beam in a spot non-uniform, the laser beam irradiation optical unit can melt a workpiece in a front region of the spot with respect to a movement direction and appropriately blow off the metal of the workpiece melted in a rear region of the spot even when the movement speed of the spot of the laser beam is fast. As a result, it is possible to perform laser machining without leaving a molten workpiece on a cut surface or a hole portion of the workpiece.

The energy intensity distribution adjustment mechanism has a function of adjusting the energy intensity distribution of the laser beam at the spot to be “non-uniform” . Here, when a transmission loss and a loss due to reflection of the energy intensity distribution adjustment mechanism are excluded, the energy intensity distribution adjustment mechanism non-uniformly adjusts the energy intensity distribution of the laser beam without changing the sum of the energy of an output laser beam with respect to an input laser beam. Even when the movement speed of the spot of the laser beam is fast, the non-uniformity of the energy intensity distribution of the laser beam is not limited as long as the molten workpiece is appropriately blown off and does not remain in the cut surface or the hole portion. As a specific example, the “non-uniform” energy intensity distribution is preferably a distribution in which, in an image formed by the laser beam at the spot, an energy intensity of the laser beam is weak in a front region in a traveling direction at the time of laser machining of the spot, and the energy intensity of the laser beam is strong in a rear region different from the front region (opposite to the front region). This is because even when the movement speed of the spot of the laser beam is fast, the workpiece can be melted in the front region of the spot with respect to the movement direction, and the metal of the molten workpiece can be appropriately blown off in the rear region of the spot.

Note that the “non-uniform” energy intensity distribution state is not limited to the above, and may be a distribution in which, in the image formed by the laser beam at the spot, the energy intensity of the laser beam in the front region in the traveling direction at the time of laser machining of the spot is strong and the energy intensity of the laser beam in the rear region different from the front region is weak. Furthermore, the energy intensity of the laser beam may be non-uniform in left and right regions with respect to a front-back direction in the traveling direction at the time of laser machining of the spot, or the energy intensity of the laser beam may be non-uniform in a front-back oblique region. For example, it is suitable for butt welding of materials having high reflection and different melting points, such as aluminum and copper, welding of materials having different thicknesses, a case where there is a gap between materials to be welded, and the like.

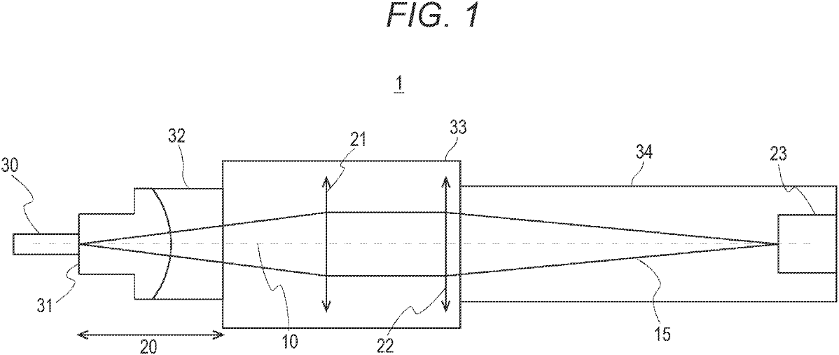

FIG. 1 is a cross-sectional view illustrating an arrangement configuration of optical elements of a laser beam irradiation optical unit 1 according to the present invention and an approximate trajectory of a laser beam. In the laser beam irradiation optical unit 1, a connector unit 31 that connects an optical fiber 30 that guides a laser beam output from a laser oscillator, a connector receiving unit 32 that fixes the connector unit 31 to an irradiation trajectory of the laser beam, a collimating lens 21 that collimates the laser beam output in a diffusing manner from an output end of the optical fiber 30, a condensing lens 22 that focuses the laser beam collimated by the collimating lens 21 on a spot on a surface of an object to be machined, and an observation device 23 that observes observation light for confirming an intensity distribution of the laser beam at the spot are arranged in order from a laser oscillator side along an optical axis 10 of the irradiation trajectory of the laser beam irradiation optical unit 1. An optical center of the collimating lens 21 and an optical center of the condensing lens 22 are disposed so as to coincide with the optical axis 10.

In FIG. 1, a laser beam direction adjustment mechanism 20, the collimating lens 21, and the condensing lens 22 are arranged along the optical axis 10 in order from the laser oscillator side. However, as long as the energy intensity distribution of the laser beam at the spot can be adjusted to be “non-uniform”, the laser beam direction adjustment mechanism 20, the condensing lens 22, and the collimating lens 21 may be arranged in order from the laser oscillator side.

Any laser beam can be used as the laser beam incident on the laser beam irradiation optical unit 1 from the laser oscillator as long as the laser beam can be used for laser machining. In particular, a near-infrared laser beam having an oscillation wavelength of about 920 to 1080 nm typified by a YAG laser (wavelength 1064 nm), a fiber laser (wavelength 1070 nm), a disk laser (wavelength 1030 nm), and a semiconductor laser (wavelength 935 nm, 940 nm, 980 nm, 940 to 980 nm, 940 to 1025 nm) is preferable. In addition, an energy distribution in a plane perpendicular to the optical axis of the laser beam incident on the laser beam irradiation optical unit 1 may be a Gaussian shape in which the energy in a center portion (optical axis portion) is strong or uniform.

The laser beam direction adjustment mechanism 20 includes the connector unit 31 to which the optical fiber 30 is connected and the connector receiving unit 32 that fixes the connector unit 31 to the optical axis 10 of the irradiation trajectory, and adjusts an incident direction of the laser beam on the irradiation trajectory by turning at least one of the connector unit 31 and the connector receiving unit 32 in an arc shape with a center portion of a core of the optical fiber 30 at the laser beam output end as a center point.

In FIG. 1, the connector receiving unit 32, the collimating lens 21, and the condensing lens 22 are installed in a lens barrel 33 such that their respective optical centers coincide with the optical axis 10. Then, an observation cylinder 34 including the observation device 23 is connected to the lens barrel 33. At this time, the observation cylinder 34 may have a structure detachable from the lens barrel 33. By connecting the detachable observation cylinder 34 including the observation device 23 to the lens barrel 33 constituting the optical axis 10 of the irradiation trajectory of the laser beam, it is possible to confirm the incident direction of the laser beam on the irradiation trajectory and confirm the energy intensity distribution of the observation light at the spot when the adjustment is performed using the energy intensity distribution adjustment mechanism according to the present invention. Then, after the observation by the observation device 23 is performed to adjust the intensity distribution of the laser beam at the spot to be desirable, the observation cylinder 34 is removed, and the surface of the object to be machined is positioned at the position where an imaging surface of the observation device 23 is located, whereby laser machining can be performed with high accuracy.

Note that, before the laser beam is incident on the observation device 23, it is preferable to reduce the intensity of the laser beam to an observable level without damaging the observation device 23. Any light reducing element can be used as long as it reduces the intensity of the laser beam without distorting the light incident on the observation device 23. Note that the observation light incident on the observation device 23 is not limited to the laser beam used for machining or the dimmed laser beam, and it is also preferable to use observation light for observation called guide light or aiming light different from the laser beam used for machining. This is because the energy intensity of the observation light for observation is not at a level that damages the observation device 23, and there is no need to reduce the light.

Here, at least one of the collimating lens 21 and the condensing lens 22 of the laser beam irradiation optical unit 1 preferably has a function (hereinafter, it is referred to as an annular conversion function in the present specification) of converting the image shape of the laser beam at the spot into an annular shape including at least an annular peripheral region. The annular conversion function is different from the function of “non-uniformly adjusting the energy intensity distribution of the laser beam” by the energy intensity distribution adjustment mechanism described above, and in a case where the adjustment by the energy intensity distribution adjustment mechanism is not performed on the laser beam, the energy intensity in the annular image shape becomes uniform in point symmetry with respect to the optical axis 10. When the shape of the energy distribution of the spot is an annular shape including at least an annular peripheral region, the energy of the laser beam is uniformly irradiated in any direction from a center region of the spot on the surface of the object to be machined. As a result, zinc gas is released by lap welding of the molten zinc steel plate, and clean welding can be performed.

Furthermore, the shape of the spot by the annular conversion function is not particularly limited, and may be, for example, a shape including an annular shape and a point shape (a point portion is a Gaussian shape) at the center portion of the annular shape, or may be a top-hat shape or the like. At this time, the energy intensity of the point-like spot at the center portion of the annular shape is preferably higher than the energy intensity of the annular portion. This is because, in aluminum or the like having a high light reflectance, the metal can be melted at the annular portion having a low energy intensity to lower the reflectance, and the object to be machined can be melted deeply at the central portion having a high energy intensity, so that laser machining becomes easier.

In order to form the image shape of the spot described above, at least one surface of the optical effective surface of the optical element having the annular conversion function is preferably any one of a diffractive lens, an axicon lens, and an aspherical lens. This is because the spot shape of the laser beam can be an annular shape or a shape including an annular shape and a point shape at a center portion of the annular shape.

Note that the laser beam irradiation optical unit 1 does not necessarily have the annular conversion function, and a laser beam in which an image shape of a laser beam emitted from the optical fiber 30 is an annular shape including at least an annular peripheral region may be used. By using the laser beam in which the image shape of the laser beam emitted from the optical fiber 30 is an annular shape, a combined shape of an annular shape and a point shape at the center portion of the annular shape, a top hat shape, or the like, the laser beam irradiation optical unit 1 can non-uniformly adjust the energy intensity distribution in the image shape of the laser beam. Hereinafter, an embodiment in which at least one of the collimating lens 21 and the condensing lens 22 has the annular conversion function will be described, but the laser beam irradiation optical unit 1 is not limited to one having an annular conversion function.

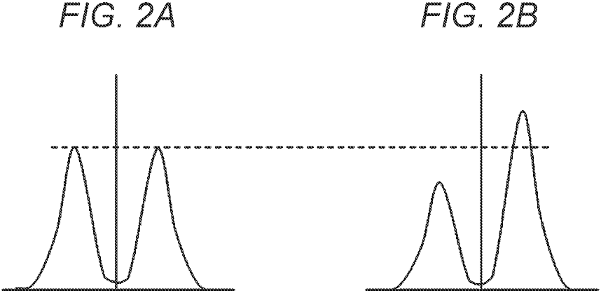

Next, the energy intensity distribution in the spot in a case where the image shape of the laser beam in the spot is annular will be described with reference to FIGS. 2A and 2B. FIG. 2A illustrates an energy intensity distribution of a laser beam at a spot in a case where the energy intensity distribution in a plane perpendicular to the optical axis of the laser beam emitted from the laser oscillator is a Gaussian shape, an image shape of the laser beam at the spot is an annular shape by using the annular conversion function, and the energy intensity distribution of the laser beam is not non-uniformly adjusted by the energy intensity distribution adjustment mechanism. A horizontal axis is a coordinate on a straight line perpendicular to the optical axis including the optical axis of the spot, and a direction from a positive side (right side) to a negative side (left side) of the coordinate is a traveling direction of the spot at the time of laser machining. That is, a first quadrant in FIG. 2A corresponds to a rear region in the traveling direction of the laser machining, and a second quadrant corresponds to a front region. The center of the horizontal axis indicates the position of the optical axis of the laser beam irradiation optical unit 1. A vertical axis indicates the energy intensity of the laser beam. A broken line in FIGS. 2A and 2B indicates a peak value of the energy intensity in FIG. 2A. That is, when the energy intensity distribution is not non-uniformly adjusted by the energy intensity distribution adjustment mechanism, the energy intensity distribution of the laser beam has a uniform bimodal peak value in the front region and the rear region.

Next, FIG. 2B illustrates the energy intensity distribution of the laser beam at the spot when the energy intensity distribution of the laser beam in the state of FIG. 2A is non-uniformly adjusted using the energy intensity distribution adjustment mechanism. Similarly to FIG. 2A, the first quadrant in FIG. 2B corresponds to the rear region in the traveling direction of the laser machining, and the second quadrant corresponds to the front region. FIG. 2B illustrates a state in which the energy intensity distribution is non-uniformly adjusted by biasing the energy toward the rear region side. In this case, the energy intensity of the front region in the traveling direction of the laser machining is weak, and the energy intensity of the rear region is strong. That is, in the energy intensity distribution of the laser beam, the peak values in the front region and the rear region are “non-uniform bimodal”. Since the energy intensity distribution adjustment mechanism does not change the sum of the energy of the output laser beam with respect to the input laser beam, the sum (integral value of the energy with respect to the horizontal axis) of the energy of the laser beam illustrated in FIGS. 2A and 2B substantially coincides.

In a case where the image shape of the laser beam at the spot is an annular shape and the energy intensity distribution of the laser beam is a uniform bimodal shape as illustrated in FIG. 2A, when the movement speed of the spot of the laser beam during laser machining is low, the molten workpiece is appropriately blown off and does not remain on the cut surface or the hole portion. However, when the movement speed of the spot of the laser beam during laser machining increases, the molten workpiece remains on the cut surface or the hole portion. However, as illustrated in FIG. 2B, in a case where the image shape of the laser beam at the spot is annular, the energy intensity of the front region in the traveling direction of the laser machining is weak, and the energy intensity of the rear region is strong and nonuniform bimodal, even when the movement speed of the spot of the laser beam during the laser machining is fast, the workpiece melted in the front region of the spot can be appropriately blown off in the rear region of the spot having the strong energy intensity. As a result, the molten workpiece does not remain on the cut surface or the hole portion.

Regarding the intensity ratio of the non-uniform energy intensity distribution of the laser beam in FIG. 2B, when the peak value of the strong energy intensity in the rear region (first quadrant) in the traveling direction at the time of laser machining of the spot is 1, the peak value of the weak energy intensity in the front region (second quadrant) is preferably 0.1 or more and 0.95 or less. As described above, for example, the laser beam having the weak energy intensity distribution and the laser beam having the strong energy intensity distribution can play different roles in the laser machining such that the workpiece is melted by the laser beam having the weak energy intensity distribution and the molten metal of the workpiece is blown by the laser beam having the strong energy intensity distribution. When the peak value of the strong energy intensity is 1, a lower limit value of the peak value of the weak energy intensity is more preferably 0.20, still more preferably 0.25. When the peak value of the strong energy intensity is 1, an upper limit value of the peak value of the weak energy intensity is more preferably 0.6, still more preferably 0.5. A comparison target of an intensity ratio of the energy intensity of the laser beam in FIG. 2B is the peak value of the energy intensity distribution forming the peak in the “non-uniform bimodal shape”, and the spot center portion (the center portion of the horizontal axis in FIG. 2B) is not the target.

In addition, the energy intensity distributions in the front region and the rear region with respect to the traveling direction of the laser machining may be non-uniform energy intensity distributions opposite to those described above. That is, regarding the intensity ratio of the energy intensity in the non-uniform energy intensity distribution of the annular portion, when the peak value of the strong energy intensity in the front region in the traveling direction at the time of laser machining of the spot is 1, the peak value of the weak energy intensity in the rear region is preferably 0.1 or more and 0.95 or less. This is because the laser beam having the weak energy intensity and the laser beam having the strong energy intensity distribution can play different roles in laser machining. When the peak value of the strong energy intensity is 1, a lower limit value of the peak value of the weak energy intensity is more preferably 0.20, still more preferably 0.25. When the peak value of the strong energy intensity is 1, an upper limit value of the peak value of the weak energy intensity is more preferably 0.6, still more preferably 0.5.

### [First Embodiment of Energy Intensity Distribution Adjustment Mechanism]

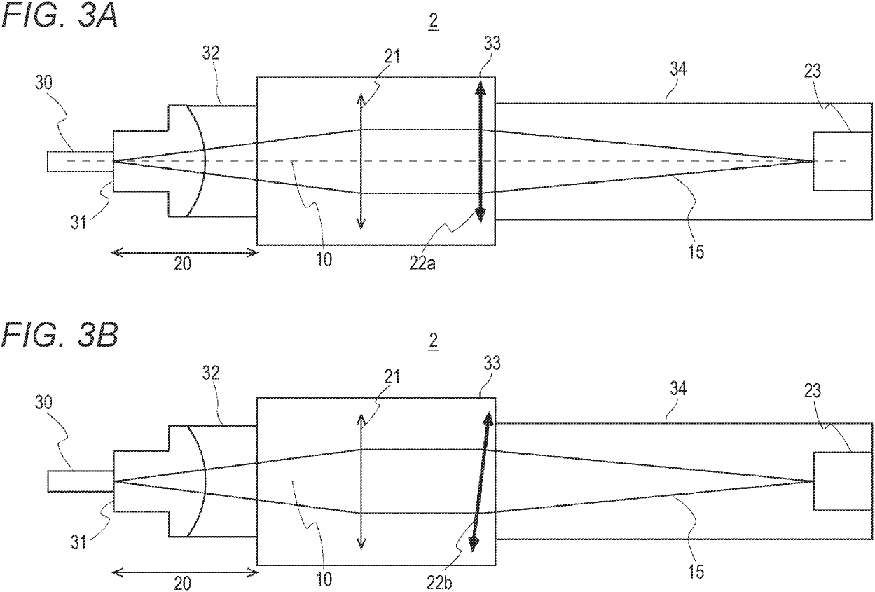

FIGS. 3A and 3B illustrate a first embodiment of the energy intensity distribution adjustment mechanism and are cross-sectional views of a laser beam irradiation optical unit 2 in a case where an energy intensity distribution of a laser beam is non-uniformly adjusted using a condensing lens 22a and a condensing lens 22b. The condensing lens 22a having the annular conversion function in FIG. 3A is in a state where the condensing lens 22a is moved in a direction (above the optical axis 10 in the drawing in FIG. 3A) parallel to a plane perpendicular to the optical axis 10. Hereinafter, in the present specification, moving the optical element in the direction parallel to the plane perpendicular to the optical axis 10 is referred to as a shift. In this case, an optical center of the condensing lens 22a is located above the optical axis 10 in the drawing. In the state of FIG. 3A, a curvature distribution of the surface of the condensing lens 22a is different between the laser beam passing through the lower half of the optical axis 10 of the condensing lens 22a and the laser beam passing through the upper half. As a result, eccentric coma aberration occurs in the direction of the meridional plane in the laser beam passing through the condensing lens 22a. In this way, the energy intensity distribution of the laser beam at the spot can be adjusted to be “non-uniform”. The degree of non-uniformity can be adjusted by a shift amount of the condensing lens 22a.

The condensing lens 22b having the annular conversion function of FIG. 3B is in a state where the condensing lens 22b is turned around a straight line perpendicular to the optical axis 10 including the optical center of the condensing lens 22b on the optical axis 10 as a rotation axis. Hereinafter, in the present specification, turning the optical element with the straight line perpendicular to the optical axis 10 including the optical center on the optical axis 10 as a rotation axis is referred to as tilt. In this case, the position of the optical center of the condensing lens 22b coincides with the optical axis 10. In the state of FIG. 3B, a normal incident angle on the surface of the condensing lens 22b is asymmetric between the laser beam passing through the upper half of the optical axis 10 of the condensing lens 22b and the laser beam passing through the lower half. As a result, the eccentric coma aberration occurs in the direction of the meridional plane in the laser beam passing through the condensing lens 22b. In this way, the energy intensity distribution of the laser beam at the spot can be adjusted to be “non-uniform”. The degree of non-uniformity can be adjusted by a tilt amount of the condensing lens 22b.

As a method of shifting the condensing lens 22a, for example, a lens holder having a function capable of shifting perpendicularly to the optical axis is used as a lens holder for fixing the condensing lens 22a, and the position of the lens holder can be shifted by pushing the lens holder with a screw or the like. In addition, as a method of tilting the condensing lens 22b, for example, a method having a function capable of tilting a lens holder to which the condensing lens 22b is fixed with a straight line including an optical center as a rotation axis is used, and the method can be performed by tilting the angle of the lens holder by pressing with a screw or the like. Note that the method is not limited to the above method as long as the condensing lens 22a can be shifted or the condensing lens 22b can be tilted. Then, the shift amount of the condensing lens 22a or the tilt amount of the condensing lens 22b is adjusted while observing the energy intensity distribution at the spot by the observation device 23 described above, and the energy intensity distribution of the laser beam at the spot can be adjusted to an appropriate “non-uniform” state.

Note that, in the above-described laser beam irradiation optical unit 2, the annular conversion function has been described as being provided in the condensing lens 22a and the condensing lens 22b, but the annular conversion function may be provided in an optical element different from the condensing lens 22a and the condensing lens 22b. For example, the collimating lens 21 may have an annular conversion function. Even in this case, in order to adjust the energy intensity distribution of the laser beam at the spot to an appropriate “non-uniform” state, similarly to the above, the shift amount of the condensing lens 22a or the tilt amount of the condensing lens 22b can be adjusted. In this case, in order to adjust the energy intensity distribution of the laser beam at the spot to a more appropriate “non-uniform” state, it is preferable to adjust the tilt amount.

### [Second Embodiment of Energy Intensity Distribution Adjustment Mechanism]

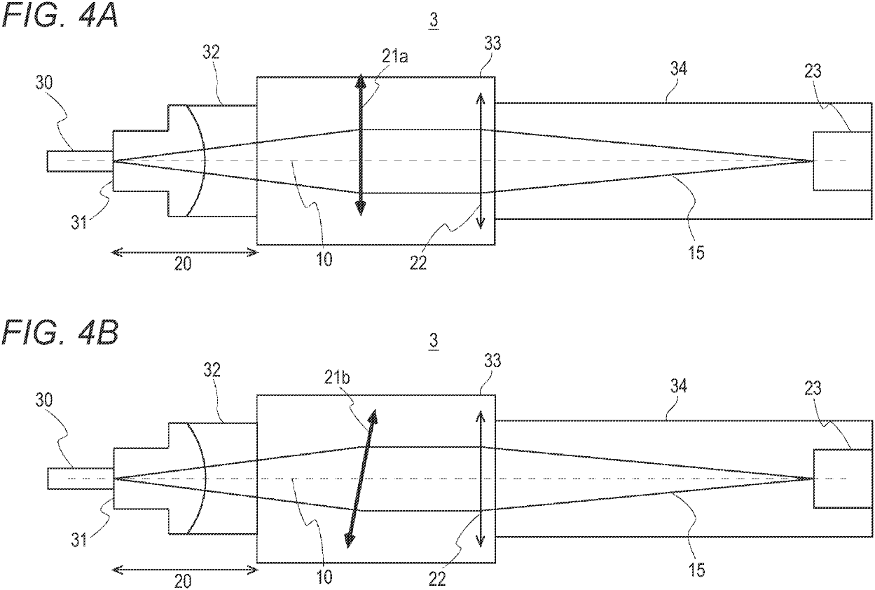

Next, FIGS. 4A and 4B illustrate a second embodiment of the energy intensity distribution adjustment mechanism and are cross-sectional views of a laser beam irradiation optical unit 3 in a case where an energy intensity distribution of a laser beam is non-uniformly adjusted using a collimating lens 21a and a collimating lens 21b. The collimating lens 21a having an annular conversion function of FIG. 4A is in a state where the collimating lens 21a is shifted in a direction (above the optical axis 10 in the drawing in FIG. 4A) parallel to a plane perpendicular to the optical axis 10. In this case, an optical center of the collimating lens 21a is located above the optical axis 10 in the drawing. In the state of FIG. 4A, a curvature distribution of the surface of the collimating lens 21a is different between the laser beam passing through the lower half of the optical axis 10 of the collimating lens 21a and the laser beam passing through the upper half. As a result, eccentric coma aberration occurs in the direction of the meridional plane in the laser beam passing through the collimating lens 21a. In this way, the energy intensity distribution of the laser beam at the spot can be adjusted to be “non-uniform”. The degree of non-uniformity can be adjusted by the shift amount of the collimating lens 21a.

The collimating lens 21b having the annular conversion function of FIG. 4B is in a state where the collimating lens 21b is tilted around a straight line including the optical center of the collimating lens 21b on the optical axis 10 as a rotation axis. In this case, the position of the optical center of the collimating lens 21b coincides with the optical axis 10. In the state of FIG. 4B, a normal incident angle on the surface of the collimating lens 21b is asymmetric between a laser beam passing through an upper half of the optical axis 10 of the collimating lens 21b and a laser beam passing through a lower half. As a result, the eccentric coma aberration occurs in the direction of the meridional plane in the laser beam passing through the collimating lens 21b. In this way, the energy intensity distribution of the laser beam at the spot can be adjusted to be “non-uniform”. The degree of non-uniformity can be adjusted by a tilt amount of the collimating lens 21b.

As a method of shifting the collimating lens 21a, for example, a lens holder having a function capable of shifting perpendicularly to the optical axis is used as the lens holder to which the collimating lens 21a is fixed, and the position of the lens holder is shifted by pushing the lens holder with a screw or the like. In addition, as a method of tilting the collimating lens 21b, for example, a method having a function capable of tilting a lens holder to which the collimating lens 21b is fixed with a straight line including an optical center as a rotation axis can be used, and the method can be performed by tilting the angle of the lens holder by pressing with a screw or the like. Note that the method is not limited to the above method as long as the collimating lens 21a can be shifted or the collimating lens 21b can be tilted. Then, the shift amount of the collimating lens 21a or the tilt amount of the collimating lens 21b is adjusted while observing the energy intensity distribution at the spot by the observation device 23 described above, and the energy intensity distribution of the laser beam at the spot can be adjusted to an appropriate “non-uniform” state.

Note that, in the above-described laser beam irradiation optical unit 3, the annular conversion function has been described as being provided by the collimating lens 21a and the collimating lens 21b, but the annular conversion function may be provided in an optical element different from the collimating lens 21a and the collimating lens 21b. For example, the condensing lens 22 may have an annular conversion function. Even in this case, in order to adjust the energy intensity distribution of the laser beam at the spot to an appropriate “non-uniform” state, similarly to the above, the shift amount of the collimating lens 21a or the tilt amount of the collimating lens 21b can be adjusted. In this case, in order to adjust the energy intensity distribution of the laser beam at the spot to a more appropriate “non-uniform” state, it is preferable to adjust the tilt amount.

### [Third Embodiment of Energy Intensity Distribution Adjustment Mechanism]

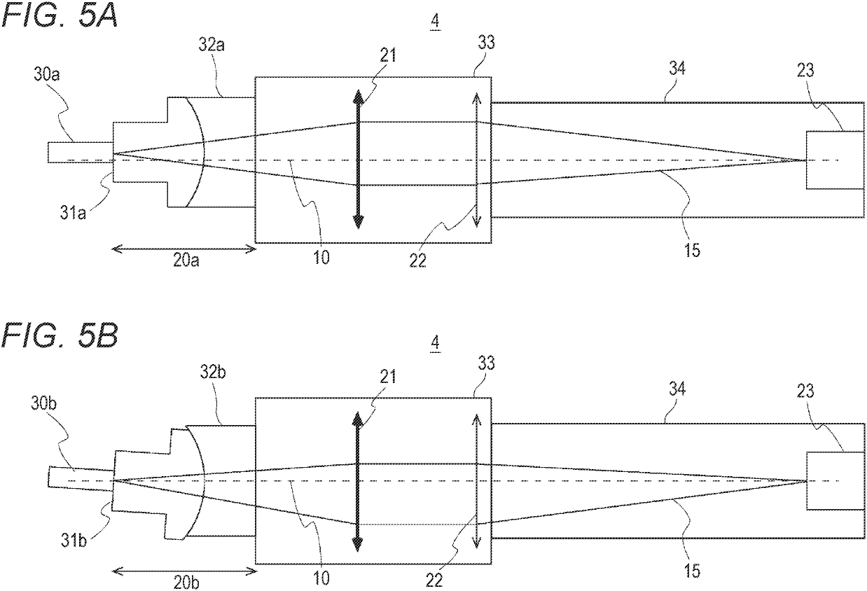

Next, FIGS. 5A and 5B illustrate a third embodiment of the energy intensity distribution adjustment mechanism and are cross-sectional views of a laser beam irradiation optical unit 4 in a case where an energy intensity distribution of a laser beam is non-uniformly adjusted using the laser beam direction adjustment mechanism 20. A laser beam direction adjustment mechanism 20a including a connector unit 31a and a connector receiving unit 32a in FIG. 5A is in a state where the entire laser beam direction adjustment mechanism 20 is shifted in a direction (above the optical axis 10 in the drawing in FIG. 5A) parallel to a plane perpendicular to the optical axis 10. An optical fiber 30a is fixed to the connector unit 31a. In this case, an optical center of the laser beam direction adjustment mechanism 20a is located above the optical axis 10 in the drawing. In the state of FIG. 5A, curvature distributions of the surfaces of the collimating lens 21 and the condensing lens 22 are different between the laser beam passing through the lower half of the optical axis 10 of the collimating lens 21 and the condensing lens 22 and the laser beam passing through the upper half. That is, the image formed on the spot has the eccentric coma aberration in the direction of a meridional plane. In this way, the energy intensity distribution of the laser beam at the spot can be adjusted to be “non-uniform”. The degree of non-uniformity can be adjusted by the shift amount of the laser beam direction adjustment mechanism 20a.

A laser beam direction adjustment mechanism 20b of FIG. 5B is in a state where the connector unit 31b to which an optical fiber 30b is fixed is tilted downward in FIG. 5B with respect to a connector receiving unit 32b using an “arc-shaped turning” function of the laser beam direction adjustment mechanism 20. Details of the “arc-shaped turning” function will be described below. In this case, the position of the optical center of the connector receiving unit 32b coincides with the optical axis 10. Here, it is assumed that an emission direction of the laser beam output from the output end of the optical fiber 30b coincides with a reference optical axis determined by a structure of an output end of the optical fiber 30b and a structure of the connector unit 31b. In the state of FIG. 5B, normal incident angles on the surfaces of the collimating lens 21 and the condensing lens 22 are asymmetric between the laser beam passing through the upper half of the optical axis 10 of the collimating lens 21 and the condensing lens 22 and the laser beam passing through the lower half thereof. As a result, the eccentric coma aberration occurs in the direction of the meridional plane in the laser beam passing through the collimating lens 21 and the condensing lens 22. In this way, the energy intensity distribution of the laser beam at the spot can be adjusted to be “non-uniform”. The degree of non-uniformity can be adjusted by the tilt amount of the laser beam direction adjustment mechanism 20b, that is, the amount of turning in an arc shape.

As a method of shifting the laser beam direction adjustment mechanism 20a, for example, a holder having a function capable of shifting perpendicularly to the optical axis is used as a holder for fixing the laser beam direction adjustment mechanism 20a, and the position of the holder can be shifted by pushing the holder with a screw or the like. The function of the “arc-shaped turning” of the laser beam direction adjustment mechanism 20b will be described below. Note that the method is not limited to the above-described method as long as the laser beam direction adjustment mechanism 20a can be shifted or the laser beam direction adjustment mechanism 20b can be tilted. Then, the shift amount of the laser beam direction adjustment mechanism 20a or the tilt amount of the laser beam direction adjustment mechanism 20b is adjusted while the energy intensity distribution at the spot is observed by the observation device 23 described above, so that the energy intensity distribution of the laser beam at the spot can be adjusted to an appropriate “non-uniform” state.

In the above-described laser beam irradiation optical unit 4, the collimating lens 21 has the annular conversion function, but the annular conversion function can be provided in at least one of the collimating lens 21 and the condensing lens 22. In either case, the shift amount of the laser beam direction adjustment mechanism 20a or the tilt amount of the laser beam direction adjustment mechanism 20b using the “arc-shaped turning” function can be adjusted to adjust the energy intensity distribution of the laser beam at the spot to an appropriate “non-uniform” state. In order to adjust the energy intensity distribution of the laser beam at the spot to a more appropriate “non-uniform” state, it is preferable to adjust the tilt amount.

As described in the first to third embodiments of the energy intensity distribution adjustment mechanism, the energy intensity distribution adjustment mechanism according to the present invention can be realized by using at least one of the laser beam direction adjustment mechanism 20, the collimating lens 21, and the condensing lens 22.

### [Laser Beam Direction Adjustment Mechanism]

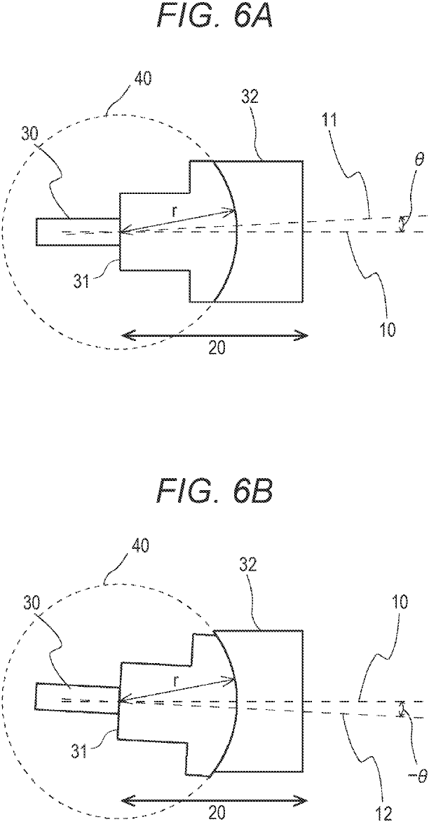

FIGS. 6A and 6B are schematic cross-sectional views of the optical fiber 30 and the laser beam direction adjustment mechanism 20. The laser beam direction adjustment mechanism 20 has a function of adjusting the incident direction of the laser beam on the irradiation trajectory in an appropriate direction even when the emission direction of the laser beam output from the output end of the optical fiber 30 is inclined. This adjustment is performed using the “arc-shaped turning” function of the laser beam direction adjustment mechanism 20. The tilt operation in the third embodiment of the energy intensity distribution adjustment mechanism according to the present invention utilizes the “arc-shaped turning” function of the laser beam direction adjustment mechanism 20.

The function of the laser beam direction adjustment mechanism 20 to adjust the incident direction of the laser beam on the irradiation trajectory to an appropriate direction will be described. The laser beam output from the laser oscillator is guided to the laser machining head of the laser machining apparatus using the optical fiber 30. The optical fiber 30 is connected to the laser beam irradiation optical unit 1 in the laser machining head via the connector unit 31. At this time, as illustrated in FIG. 6A, the emission direction 11 of the laser beam output from the output end of the optical fiber 30 has an inclination in a certain range represented by an angle θ with a central portion of the output end of the optical fiber as a center point with respect to the reference optical axis (which coincides with the optical axis 10 of the irradiation trajectory) determined by the structure portion of the output end of the optical fiber 30 and the structure of the connector unit 31. Specifically, for example, in a CW fiber laser manufactured by Raikus Fiber, an angle of an optical axis of a laser beam output from an output end of an optical fiber with respect to a reference optical axis determined by a structure portion of the output end of the optical fiber and a structure of a connector unit is 30 mrad (milliradian) or less.

FIG. 6B is a cross-sectional view illustrating an outline when the incident direction of the laser beam output from the output end of the optical fiber 30 on the irradiation trajectory is adjusted using the laser beam direction adjustment mechanism 20. In FIG. 6B, the optical fiber 30 and the connector unit 31 side are turned in an arc shape with a radius r at an angle of -θ with the central portion of the optical fiber output end as a center point by using the laser beam direction adjustment mechanism 20. A turning trajectory 40 indicates a trajectory when the connector unit 31 turns in an arc shape at a radius r. That is, a reference optical axis 12 determined by the structure of the output end of the optical fiber 30 and the structure of the connector unit 31 has the angle of -θ with respect to the optical axis 10 of the irradiation trajectory. With this adjustment, the emission direction 11 of the laser beam output from the output end of the optical fiber 30 substantially coincides with the optical axis 10 of the irradiation trajectory.

At this time, the laser beam direction adjustment mechanism 20 preferably has a structure that turns in an arc shape with the central portion of the output end of the optical fiber 30 of the laser oscillator as a center point. This is because the laser beam direction adjustment mechanism 20 has a structure in which at least one of the connector unit 31 and the connector receiving unit 32 turns in an arc shape with the center portion of the core of the optical fiber 30 at the laser beam output end as a center point, and thus, it is possible to adjust the incident direction of the laser beam output from the output end of the optical fiber with respect to the irradiation trajectory of the laser beam with respect to the reference optical axis 12 determined by the structure portion of the output end of the optical fiber 30 and the structure of the connector unit 31 to substantially coincide with the optical axis 10 of the irradiation trajectory of the laser beam of the laser beam irradiation optical unit 1.

In the laser beam direction adjustment mechanism 20, a range of a turning angle θ of the arc-shaped turning with the central portion of the output end of the optical fiber 30 as the center point is preferably -30 mrad < θ < 30 mrad when the direction of the optical axis 10 passing through the optical center of the optical element of the irradiation trajectory is 0 mrad. This is because even when there is an inclination of the emission direction 11 of the laser beam output from the output end of the optical fiber 30 with respect to the reference optical axis 12 determined by the structure portion of the output end of the optical fiber 30 and the structure of the connector unit 31, the incident direction of the laser beam on the irradiation trajectory of the laser beam irradiation optical unit 1 can be adjusted to substantially coincide with the optical axis 10 of the irradiation trajectory, and the tilt operation in the third embodiment of the energy intensity distribution adjustment mechanism can be performed.

Note that the above-described turning angle θ of the arc-shaped turning with the central portion of the output end of the optical fiber 30 as the center point indicates an angle in an arbitrary plane in a plane including the optical axis 10 of the irradiation trajectory along the optical axis 10 of the irradiation trajectory with respect to the optical axis 10 of the irradiation trajectory, and is not limited to an angle in a specific plane.

A turning mechanism of the laser beam direction adjustment mechanism 20 is, for example, on a plane orthogonal to the optical axis 10 and includes a rotation axis in the X direction and a rotation axis in the Y direction orthogonal to each other, so that it is possible to perform the arc-shaped turning with the central portion of the output end of the optical fiber 30 as a center point. However, the turning mechanism is not limited to the one described above as long as the turning mechanism can be adjusted within the range of -30 mrad < θ < 30 mrad as the turning angle θ of the arc-shaped turning with the central portion of the output end of the optical fiber 30 as the center point in an arbitrary plane including the optical axis 10 of the irradiation trajectory along the optical axis 10 of the irradiation trajectory with respect to the optical axis 10 of the irradiation trajectory.

### [Observation Device]

The observation device 23 is not particularly limited as long as it can observe the irradiation position of the laser beam adjusted using the energy intensity distribution adjustment mechanism according to the present invention and the energy intensity distribution of the laser beam, and any observation device can be used. Then, the observation cylinder 34 including the observation device 23 is preferably detachable from the lens barrel 33. When the observation cylinder 34 is connected to the lens barrel 33, the position of the imaging surface (observation point) of the observation device 23 is preferably located at the same place as the surface of the object to be machined forming the spot at the time of laser machining. Furthermore, the position of the center of the imaging surface of the observation device 23 is preferably located on the optical axis 10 and at the center of the machined portion of the object to be machined. This is because the position of the laser beam and the energy distribution of the laser beam can be observed at the same position as the surface of the object to be machined forming the spot. Then, after the energy intensity distribution of the laser beam at the spot is adjusted to an appropriate “non-uniform” state, the observation device 23 is removed, and the surface of the object to be machined is arranged so as to be located at the position of the imaging surface of the observation device 23, whereby the object to be machined can be machined.

### (Collimating Lens)

The collimating lens 21 is an optical element for collimating the laser beam radially output from the output end of the optical fiber 30.

### [Condensing Lens]

The condensing lens 22 is an optical element for condensing the laser beam converted into parallel light by the collimating lens 21 on a spot.

### [Method for Adjusting Energy Intensity Distribution]

A specific method of adjusting the energy intensity distribution of the laser beam at the spot to an appropriate “non-uniform” state will be described using the first to third embodiments of the energy intensity distribution adjustment mechanism of the laser beam irradiation optical unit 1. Note that this adjustment method is not limited to the method described below.

Here, a case where the image shape of the laser beam at the spot on the surface of the object to be machined is annular will be described. From the spot image of the laser beam captured by the observation device 23, an energy intensity distribution on a first coordinate axis including the center of the imaging surface and on the traveling direction of the spot at the time of laser machining is extracted. Then, with the center of the imaging surface as an origin of the first coordinate axis, values obtained by integrating the energy intensity distribution values on a minus coordinate side and a plus coordinate side on the first coordinate axis are defined as EM1 and EP1. Similarly, the energy intensity distribution on a second coordinate axis orthogonal to the first coordinate axis is extracted, the center of the imaging surface is set as an origin of the second coordinate axis, and values obtained by integrating the energy intensity distribution values on the minus coordinate side and the plus coordinate side on the second coordinate axis are defined as EM2 and EP2. At this time, by comparing the sizes of EM1, EP1, EM2, and EP2, it is possible to know the distribution of the energy intensity of the spot image on the coordinate plane including the first coordinate axis and the second coordinate axis.

Further, from the spot image of the laser beam captured by the observation device 23, peak values of the energy intensity values on the minus coordinate side and the plus coordinate value and coordinate values indicating the peak values are extracted on the first coordinate axis and the second coordinate axis. From the peak value of the energy intensity value and the coordinate value indicating the peak value, it is possible to know the non-uniform state of the shape of the energy intensity distribution on the traveling direction of the spot and the intensity ratio of the energy intensity.

From the energy intensity distribution information of the laser beam at the spot confirmed in this manner, the energy intensity distribution of the laser beam at the spot can be adjusted to an appropriate “non-uniform” state using any one of the first to third embodiments of the energy intensity distribution adjustment mechanism. After the adjustment, the energy intensity distribution in the spot of the laser beam is confirmed again by the above-described method, and the completion of the adjustment can be determined by, for example, a distribution state of the energy intensity in which the sizes of EM1, EP1, EM2, and EP2 are compared, and a determination criterion such as whether the difference between the peak values of the front region and the rear region in the traveling direction of the spot is within a range of an allowable value of the intensity ratio of the energy intensity. Then, in a case where adjustment cannot be made within the determination criterion by one adjustment, readjustment can be performed by the above-described method. In this way, an appropriate energy distribution can be obtained at the spot.

In the first to third embodiments of the energy intensity distribution adjustment mechanism, when the energy intensity distribution of the laser beam at the spot is adjusted to an appropriate non-uniform state, the center position (spot center position) between the front region and the rear region of the image at the spot may deviate from the position of the optical axis. In this case, by adjusting the energy intensity distribution of the laser beam at the spot to an appropriate non-uniform state and then measuring the deviation of the spot center position from the optical axis 10, the spot center position can be correctly adjusted to the machining position of the workpiece at the time of laser machining.

In addition, as described above, since the energy intensity distribution at the spot can be obtained as numerical information from the observation device 23, it is also possible to automate the adjustment by causing the control device of the laser beam irradiation optical unit 1 to learn the observation value obtained from the observation device 23 in advance according to the magnitude of the adjustment by the energy intensity distribution adjustment mechanism.

### 2. Laser Machining Apparatus

The laser machining apparatus according to the present invention is obtained by accommodating the above-described laser beam irradiation optical unit 1 in a laser machining head of the laser machining apparatus. As a result, the object to be machined can be irradiated with the laser beam and machined by heating and melting. Further, the laser machining apparatus according to the present invention can adjust the energy intensity distribution of the laser beam at the spot to an appropriate “non-uniform” state by using the first to third embodiments of the energy intensity distribution adjustment mechanism using at least one of the laser beam direction adjustment mechanism 20, the collimating lens 21, and the condensing lens 22. Further, the “non-uniform” can be a distribution in which the energy intensity of the laser beam is weak in the front region in the traveling direction at the time of laser machining of the spot with a straight line perpendicular to the optical axis including the optical axis of the spot as a boundary, and the energy intensity of the laser beam is strong in the rear region different from the front region.

Therefore, even when the movement speed of the spot of the laser beam is fast, the laser machining apparatus melts the workpiece in the front region of the spot with respect to the movement direction, and appropriately blows off the metal of the workpiece melted in the rear region of the spot so as not to remain in the cut surface or the hole portion.

The embodiments according to the present invention described above are one aspect of the present invention, and can be appropriately modified without departing from the gist of the present invention. In addition, the present invention will be more specifically described below with reference to Examples, but the present invention is not limited to the following Examples.

### Example 1

The optical system of the third embodiment of the energy intensity distribution adjustment mechanism illustrated in FIG. 5B was selected as the laser beam irradiation optical unit of Example 1. As the laser oscillator, a single mode fiber laser YLS-6000 (manufactured by IPG Photonics) having a laser beam wavelength of 1070 nm was used. Since the mode is the single mode, the energy intensity distribution at the spot is a Gaussian shape. The laser beam output from the YLS-6000 was connected to the connector unit 31b via the optical fiber 30b. Note that the emission direction of the laser beam emitted from the optical fiber 30b substantially coincides with the optical axis 10. A lens having a focal length of 200 mm was used as the collimating lens 21 having an annular conversion function. As the condensing lens 22, a lens having an aspherical surface with a focal length of 200 mm was used. Forcus Monitor FM+ (manufactured by PRIMES) was used as the observation device 23. Then, the laser beam direction adjustment mechanism 20b, the collimating lens 21, the condensing lens 22, and the observation device 23 were arranged along the optical axis of the optical system of Example 1 in order from the laser oscillator side.

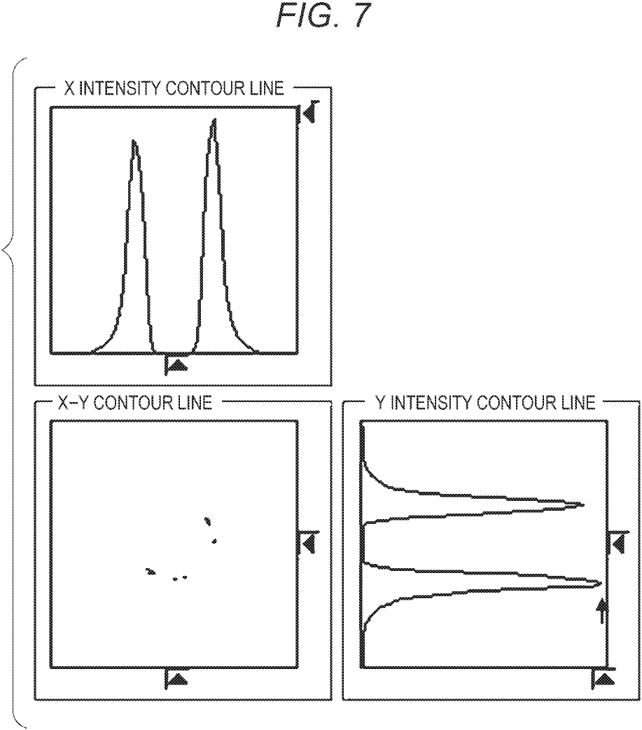

Then, the output of YLS-6000 was set to 600 W, and measurement was performed by operating Forcus Monitor FM+ using Laser Diagnosis Software (manufactured by PRIMES). FIG. 7 illustrates a measurement result when the angle of the tilt amount using the “arc-shaped turning” function of the laser beam direction adjustment mechanism 20b is 0°. An X Intensity contour line in FIG. 7 represents an energy intensity distribution of a spot at an arbitrary coordinate in a plane perpendicular to the optical axis of the optical system of Example 1, and a horizontal axis (X axis) represents a coordinate in which the center coincides with the position of the optical axis, and a vertical axis represents energy intensity (the upper axis represents high energy). A Y Intensity contour line represents an energy intensity distribution of a spot in coordinates orthogonal to the coordinate system of the X Intensity contour line. A vertical axis (Y axis) represents coordinates in which the center coincides with the position of the optical axis, and a horizontal axis represents energy intensity (the right side represents high energy). An X-Y contour line is obtained by drawing a portion where a laser beam having the same intensity as the energy intensity of an arrow portion (the peak value of the energy intensity in the case of FIG. 7) in the Y Intensity contour line diagram exists on a plane formed by the coordinates of the X axis and the Y axis. A horizontal direction is the X-axis direction, a vertical direction is the Y-axis direction, and the center of the X-Y contour line diagram is the origin of each axis. At this time, the annular diameter indicating the peak value of the spot was about 0.43 mm. The energy intensity of the arrow portion in the Y Intensity contour line diagram was 688.42 kW/cm².

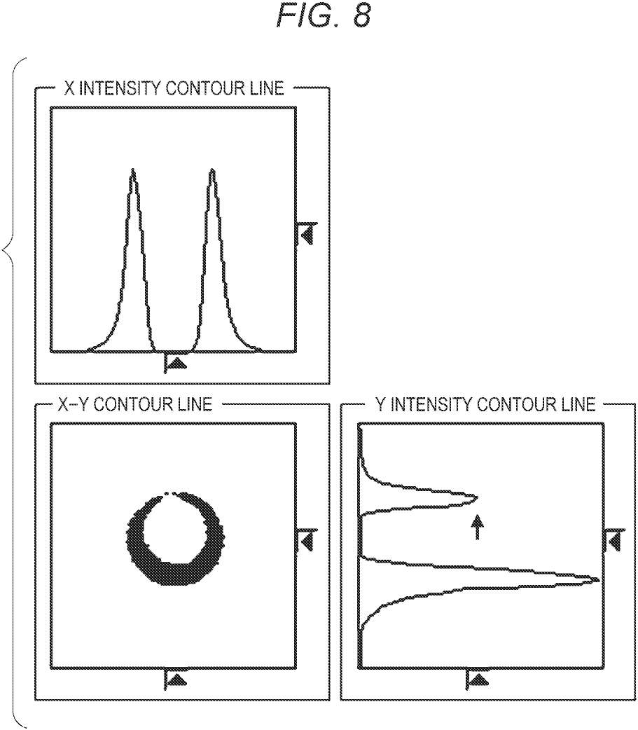

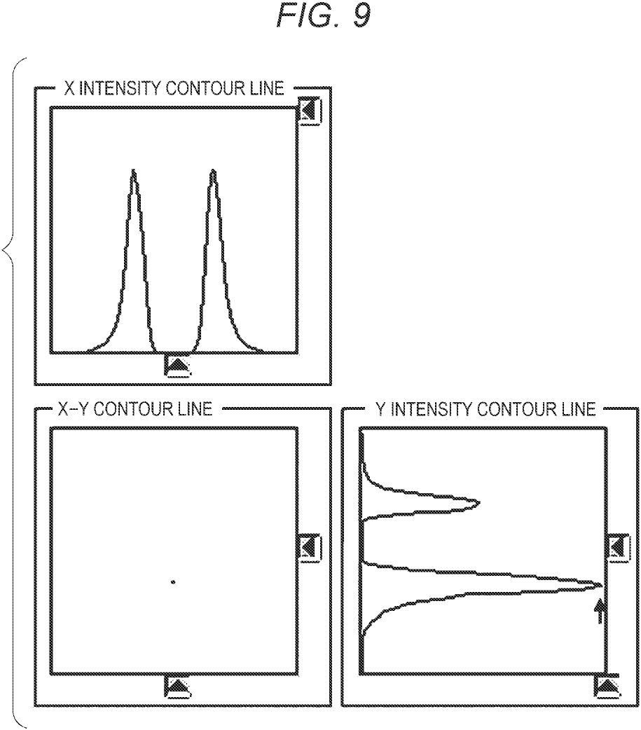

Next, measurement results in a case where the angle of the tilt amount using the “arc-shaped turning” function of the laser beam direction adjustment mechanism 20b is 3° are illustrated in FIGS. 8 and 9. The information displayed in FIGS. 8 and 9 is the same as that described in FIG. 7 except that the X-Y contour line of FIG. 8 is a drawing of a portion where a laser beam having the same intensity as the energy intensity of the arrow portion in the Y Intensity contour line diagram of FIG. 8 exists, and the X-Y contour line of FIG. 9 is a drawing of a portion where a laser beam having the same intensity as the energy intensity of the arrow portion in the Y Intensity contour line diagram of FIG. 9 exists. From the Y Intensity contour line diagrams of FIGS. 8 and 9, it was confirmed that the energy intensity distribution of the laser beam at the spot in the Y-axis direction can be adjusted to be “non-uniform” by tilting using the “arc-shaped turning” function of the laser beam direction adjustment mechanism 20b.

The energy intensity of the arrow portion in the Y Intensity contour line drawing of FIG. 8 was 396.28 kW/cm², and the energy intensity of the arrow portion in the Y Intensity contour line diagram of FIG. 9 was 810.61 kW/cm². That is, it was confirmed that the energy intensity on the strong energy intensity side after the energy intensity was adjusted to “non-uniform” had a value larger than the energy intensity before the adjustment to “non-uniform”. As a result, it has been confirmed that the energy intensity distribution adjustment mechanism (the laser beam direction adjustment mechanism in Example 1) hardly changes the sum of the energy of the output laser beam with respect to the input laser beam even when the energy intensity distribution of the laser beam is non-uniformly adjusted.

### Example 2

The optical system of the first embodiment of the energy intensity distribution adjustment mechanism illustrated in FIG. 3A was selected as the laser beam irradiation optical unit of Example 2. Here, the connector unit 31 that connects the optical fiber 30 that guides the laser beam having a Gaussian (single mode) energy intensity distribution output from the laser oscillator, the connector receiving unit 32 that fixes the connector unit 31 to the irradiation trajectory of the laser beam, the collimating lens 21 having a focal length of 200 mm for collimating the laser beam output in a diffusing manner from the output end of the optical fiber 30, and the condensing lens 22a having an aspherical surface having a focal length of 200 mm and having the annular conversion function for condensing the laser beam collimated by the collimating lens 21 on a spot on the surface of the object to be machined were used. Then, the laser beam direction adjustment mechanism 20, the collimating lens 21, the condensing lens 22a, and the observation device 23 were arranged along the optical axis of the optical system of Example 2 in order from the laser oscillator side. Note that the observation device 23 for observing the observation light for confirming the intensity distribution of the laser beam at the spot was used as an observation point at the time of optical simulation.

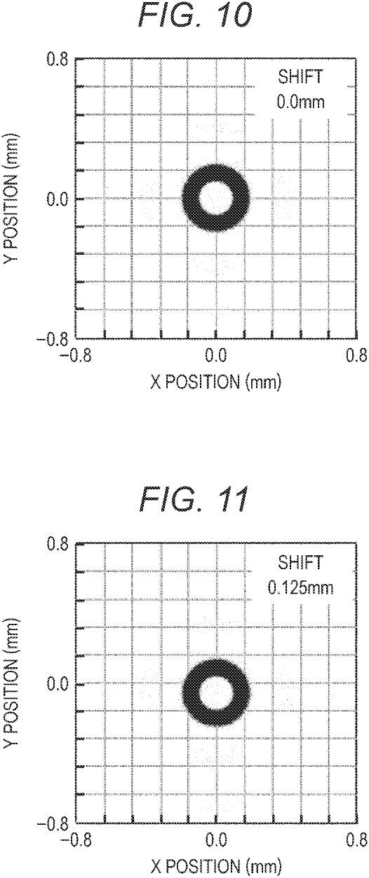

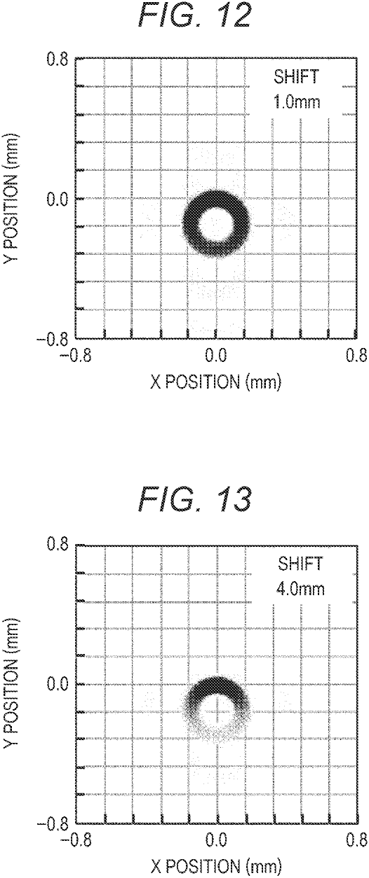

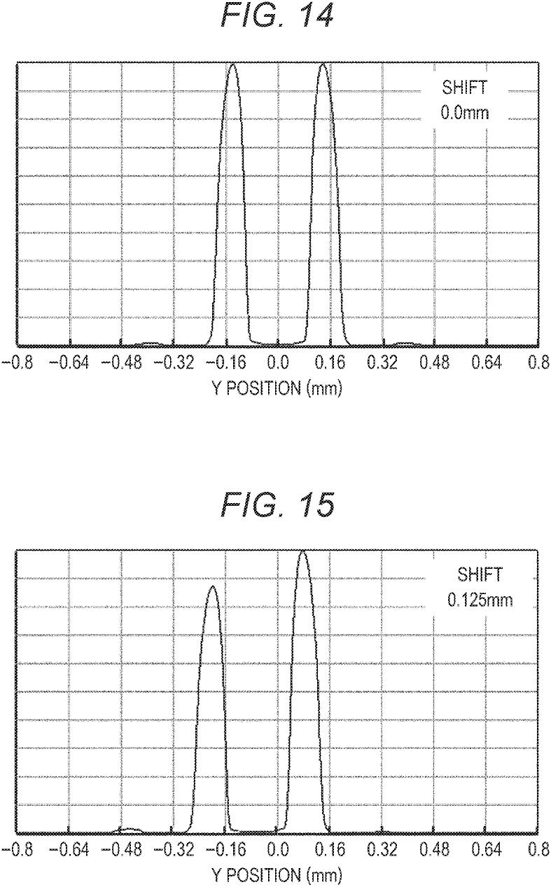

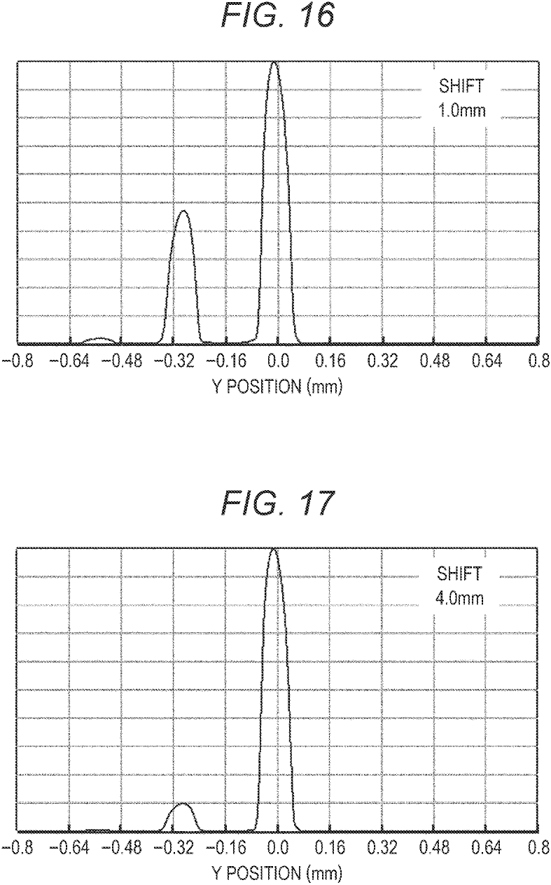

Then, the laser beam having a wavelength of 1070 nm was set to be incident on the connector unit 31 from the optical fiber 30, and simulation was performed using an optical simulator Zemax OpticStudio (Zemax, manufactured by LLc). FIGS. 10 to 17 illustrate simulation results of the energy intensity distribution at spots when the condensing lens 22a is shifted by 0.0 mm, 0.125 mm, 1.0 mm, and 4.0 mm. FIGS. 10 to 13 illustrate the energy distribution in the image shape of the laser beam formed on the imaging surface of the observation device 23, and the negative side at the Y position of the vertical axis corresponds to the front region during the laser machining, and the positive side corresponds to the rear region. The X position on the horizontal axis indicates coordinates orthogonal to the vertical axis. A relative ratio of the intensity of the energy intensity at this time is indicated by the color density. In addition, FIGS. 14 to 17 illustrate the energy intensity distribution in the Y position direction at the position where the X position in FIGS. 10 to 13 is 0, the horizontal axis indicates the Y position, and the vertical axis indicates the energy intensity of the laser beam.

From FIGS. 10 to 13, by shifting the condensing lens 22a to 0.0 mm, 0.125 mm, 1.0 mm, and 4.0 mm, it was possible to confirm that the energy intensity distribution changed from uniform to non-uniform while the image shape was maintained in an annular shape by the change in color density. From FIGS. 14 to 17, with respect to the intensity ratio of the energy intensity in the front region and the rear region, when the energy intensity in the rear region was 1.0, the energy intensity in the front region was 1.0 at the time of 0.0 mm shift, whereas the energy intensity was 0.87 at the time of 0.125 mm shift, 0.48 at the time of 1.0 mm shift, and 0.10 at the time of 4.0 mm shift.

### Example 3

The laser beam irradiation optical unit of Example 3 has the same configuration as that of Example 2 except that the optical system of the first embodiment of the energy intensity distribution adjustment mechanism illustrated in FIG. 3B is selected and the same lens as the condensing lens 22a of Example 2 is used for the condensing lens 22b.

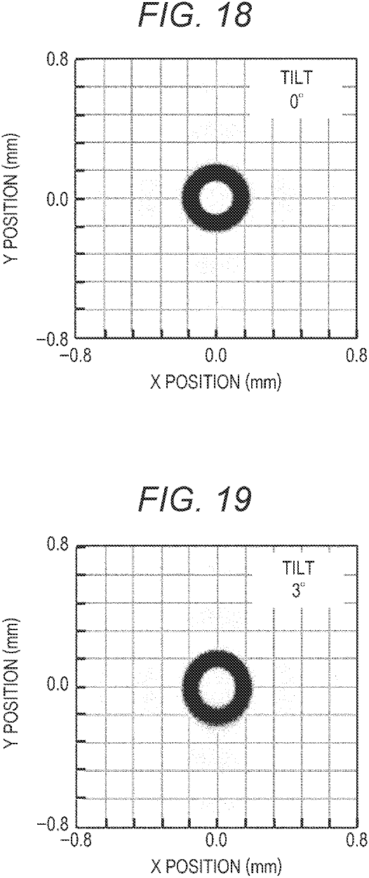

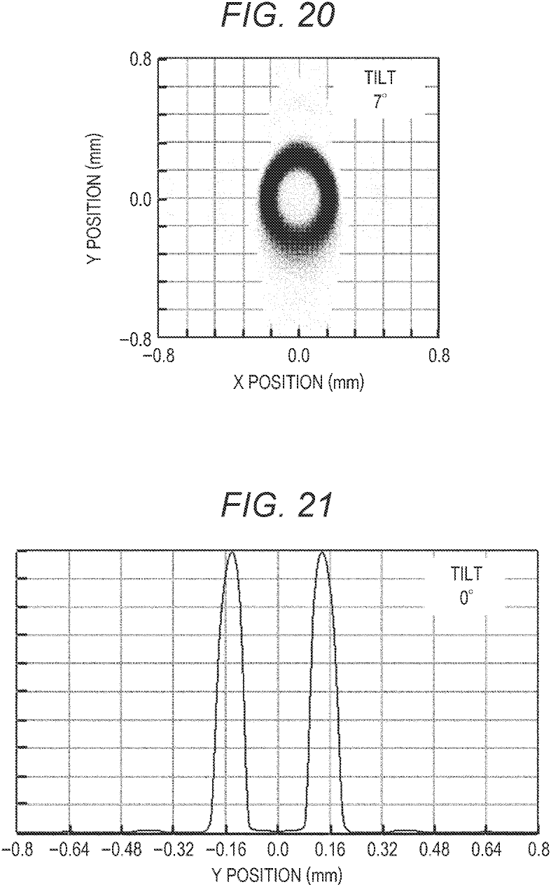

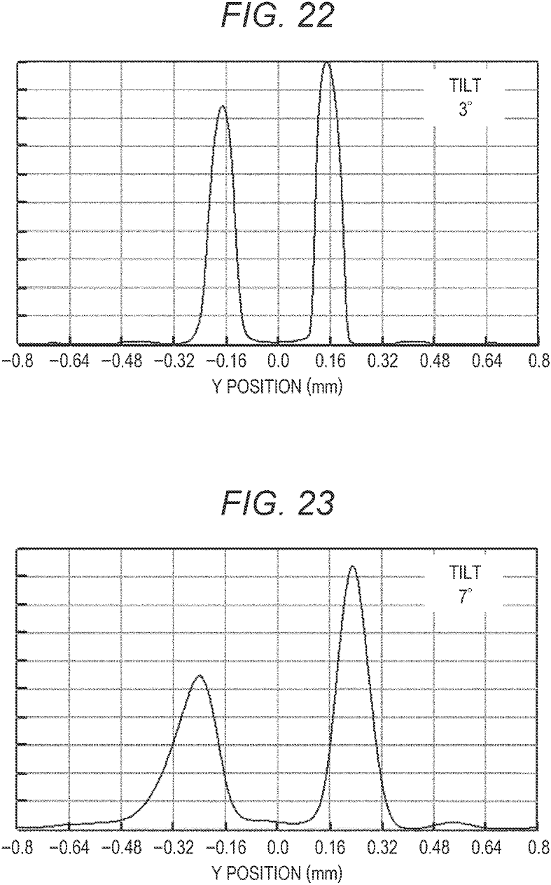

Then, the laser beam having a wavelength of 1070 nm was set to be incident on the connector unit 31 from the optical fiber 30, and simulation was performed using an optical simulator Zemax OpticStudio (Zemax, manufactured by LLc). FIGS. 18 to 23 illustrate simulation results of the energy intensity distribution in the spot when the angle of the tilt amount of the condensing lens 22b is 0°, 3°, and 7°. FIGS. 18 to 20 illustrate the energy distribution in the image shape of the laser beam formed on the imaging surface of the observation device 23, and the negative side at the Y position of the vertical axis corresponds to the front region during the laser machining, and the positive side corresponds to the rear region. The X position on the horizontal axis indicates coordinates orthogonal to the vertical axis. A relative ratio of the intensity of the energy intensity at this time is indicated by the color density. In addition, FIGS. 21 to 23 illustrate the energy intensity distribution in the Y position direction at the position where the X position in FIGS. 18 to 20 is 0, the horizontal axis indicates the Y position, and the vertical axis indicates the energy intensity of the laser beam.

From FIGS. 18 to 20, by setting the tilt angle of the condensing lens 22b to 0°, 3°, and 7°, it was possible to confirm that the energy intensity distribution changed from uniform to non-uniform while the image shape was maintained in an annular shape by the change in color density. From FIGS. 21 to 23, with respect to the intensity ratio of the energy intensity in the front region and the rear region, when the energy intensity of the rear region was 1.0, the energy intensity of the front region was 1.0 at the time of 0° tilt, whereas the energy intensity was 0.85 at the time of 3° tilt and 0.59 at the time of 7° tilt.

### Example 4

The optical system of the second embodiment of the energy intensity distribution adjustment mechanism illustrated in FIG. 4A was selected as the laser beam irradiation optical unit of Example 4. Here, a lens having an aspherical surface with a focal length of 200 mm having an annular conversion function was used as the collimating lens 21a, and a lens with a focal length of 200 mm was used as the condensing lens 22. Then, the laser beam direction adjustment mechanism 20, the collimating lens 21a, the condensing lens 22, and the observation device 23 were arranged along the optical axis of the optical system of Example 4 in order from the laser oscillator side. Note that the observation device 23 for observing the observation light for confirming the intensity distribution of the laser beam at the spot was used as an observation point at the time of optical simulation.

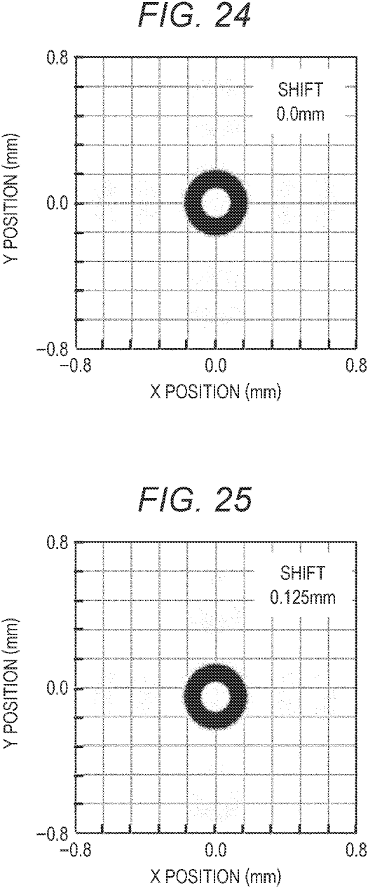

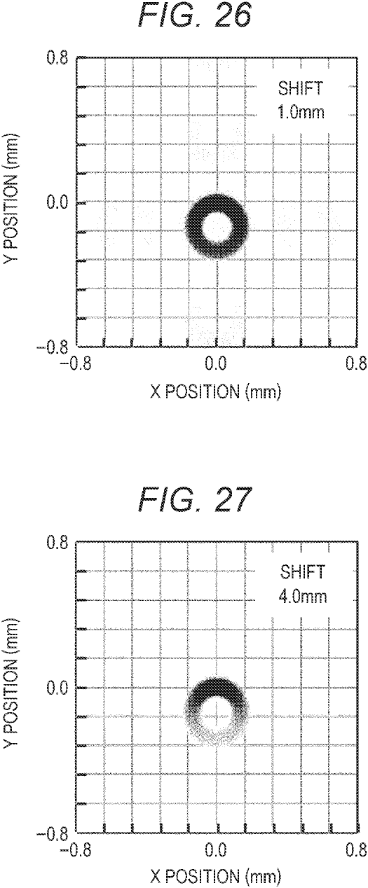

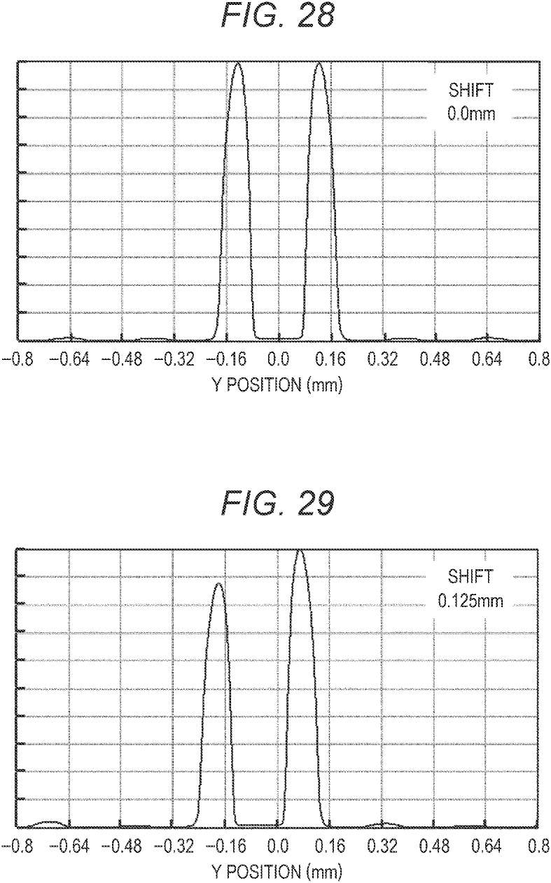

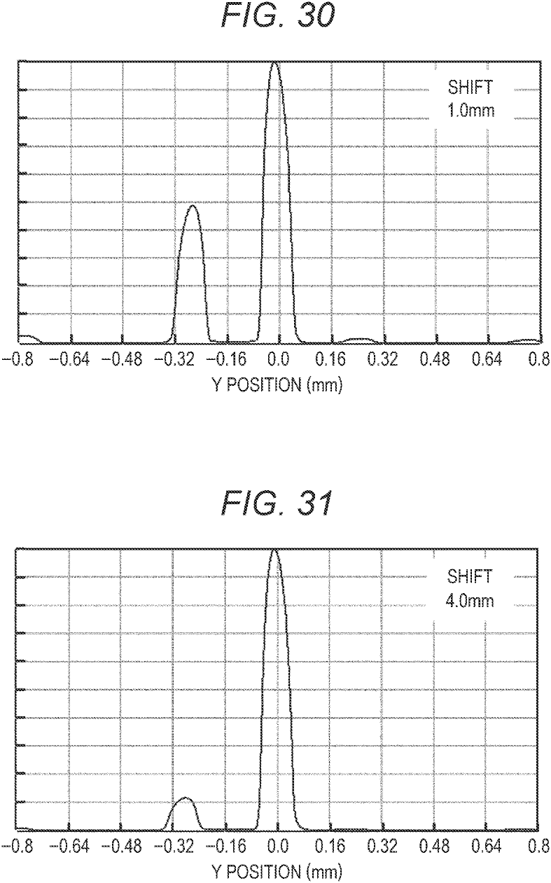

Then, the laser beam having a wavelength of 1070 nm was set to be incident on the connector unit 31 from the optical fiber 30, and simulation was performed using an optical simulator Zemax OpticStudio (Zemax, manufactured by LLc). FIGS. 24 to 31 illustrate simulation results of energy intensity distributions at spots when the collimating lens 21a is shifted by 0.0 mm, 0.125 mm, 1.0 mm, and 4.0 mm. FIGS. 24 to 27 illustrate the energy distribution in the image shape of the laser beam formed on the imaging surface of the observation device 23, and the negative side at the Y position of the vertical axis corresponds to the front region during the laser machining, and the positive side corresponds to the rear region. The X position on the horizontal axis indicates coordinates orthogonal to the vertical axis. A relative ratio of the intensity of the energy intensity at this time is indicated by the color density. In addition, FIGS. 28 to 31 illustrate the energy intensity distribution in the Y position direction at the position where the X position in FIGS. 24 to 27 is 0, the horizontal axis indicates the Y position, and the vertical axis indicates the energy intensity of the laser beam.

From FIGS. 24 to 27, by shifting the collimating lens 21a to 0.0 mm, 0.125 mm, 1.0 mm, and 4.0 mm, it was possible to confirm that the energy intensity distribution changed from uniform to non-uniform while the image shape was maintained in an annular shape by the change in color density. From FIGS. 28 to 31, with respect to the intensity ratio of the energy intensity in the front region and the rear region, when the energy intensity in the rear region was 1.0, the energy intensity in the front region was 1.0 at the time of 0.0 mm shift, whereas the energy intensity was 0.88 at the time of 0.125 mm shift, 0.49 at the time of 1.0 mm shift, and 0.12 at the time of 4.0 mm shift.

### Example 5

The laser beam irradiation optical unit of Example 5 has the same configuration as that of Example 4 except that the optical system of the second embodiment of the energy intensity distribution adjustment mechanism illustrated in FIG. 4B is selected, and the same lens as the collimating lens 21a of Example 4 is used for the collimating lens 21b.

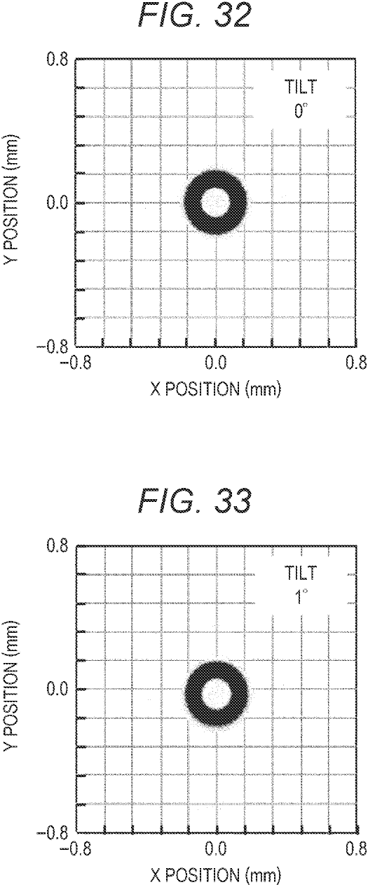

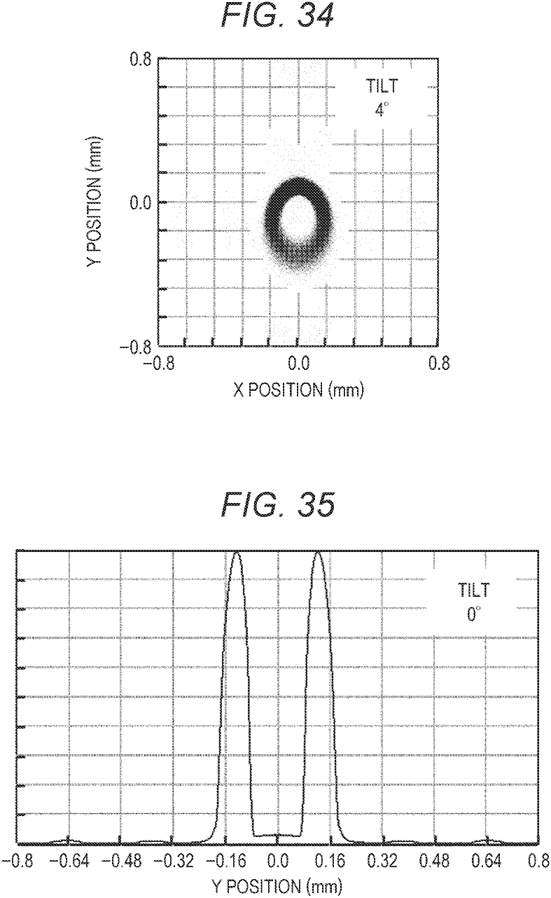

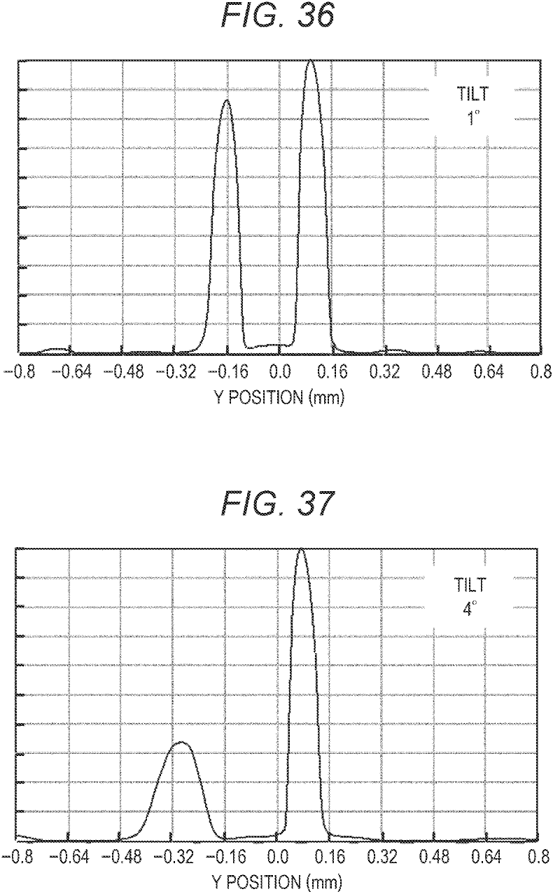

Then, the laser beam having a wavelength of 1070 nm was set to be incident on the connector unit 31 from the optical fiber 30, and simulation was performed using an optical simulator Zemax OpticStudio (Zemax, manufactured by LLc). FIGS. 32 to 37 illustrate simulation results of the energy intensity distribution in the spot when the angle of the tilt amount of the collimating lens 21b is 0°, 1°, and 4°. FIGS. 32 to 34 illustrate the energy distribution in the image shape of the laser beam formed on the imaging surface of the observation device 23, and the negative side at the Y position of the vertical axis corresponds to the front region during the laser machining, and the positive side corresponds to the rear region. The X position on the horizontal axis indicates coordinates orthogonal to the vertical axis. A relative ratio of the intensity of the energy intensity at this time is indicated by the color density. In addition, FIGS. 35 to 37 illustrate the energy intensity distribution in the Y position direction at the position where the X position in FIGS. 32 to 34 is 0, the horizontal axis indicates the Y position, and the vertical axis indicates the energy intensity of the laser beam.

From FIGS. 32 to 34, by setting the angle of the tilt amount of the collimating lens 21b to 0°, 1°, and 4°, it was possible to confirm that the energy intensity distribution changed from uniform to non-uniform while the image shape was maintained in an annular shape by the change in color density. From FIGS. 35 to 37, with respect to the intensity ratio of the energy intensity in the front region and the rear region, when the energy intensity of the rear region was 1.0, the energy intensity of the front region was 1.0 at the time of 0° tilt, whereas the energy intensity was 0.86 at the time of 1° tilt and 0.34 at the time of 4° tilt.

### Example 6

The optical system of the third embodiment of the energy intensity distribution adjustment mechanism illustrated in FIG. 5A was selected as the laser beam irradiation optical unit of Example 6. Here, a lens having an aspherical surface having a focal length of 200 mm and having an annular conversion function was used as the collimating lens 21, and a lens having a focal length of 200 mm was used as the condensing lens 22. Then, the laser beam direction adjustment mechanism 20a, the collimating lens 21, the condensing lens 22, and the observation device 23 were arranged along the optical axis of the optical system of Example 6 in order from the laser oscillator side. Note that the observation device 23 for observing the observation light for confirming the intensity distribution of the laser beam at the spot was used as an observation point at the time of optical simulation.

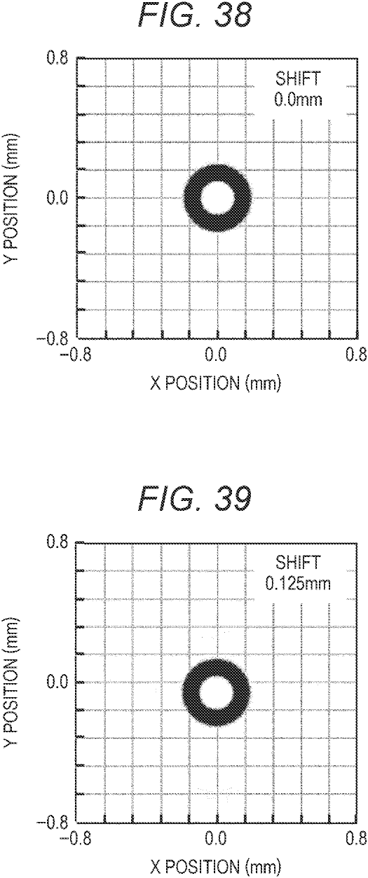

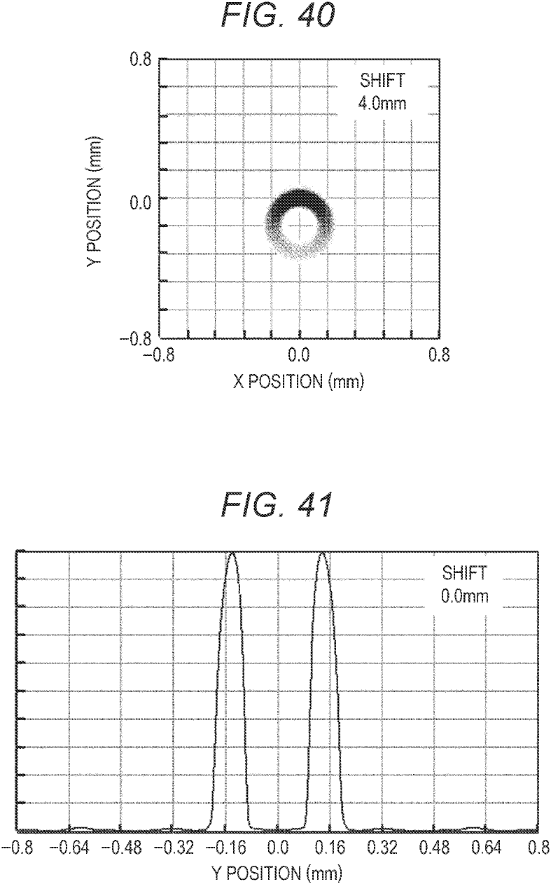

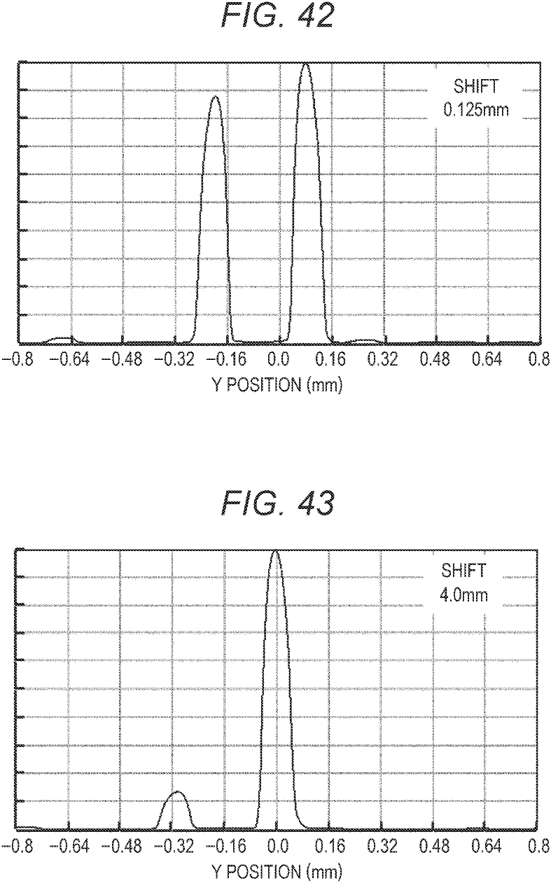

Then, the laser beam having a wavelength of 1070 nm was set to be incident on the connector unit 31 from the optical fiber 30, and simulation was performed using an optical simulator Zemax OpticStudio (Zemax, manufactured by LLc). FIGS. 38 to 43 illustrate simulation results of energy intensity distributions at spots when the laser beam direction adjustment mechanism 20a is shifted by 0.0 mm, 0.125 mm, and 4.0 mm. FIGS. 38 to 40 illustrate the energy distribution in the image shape of the laser beam formed on the imaging surface of the observation device 23, and the negative side at the Y position of the vertical axis corresponds to the front region during the laser machining, and the positive side corresponds to the rear region. The X position on the horizontal axis indicates coordinates orthogonal to the vertical axis. A relative ratio of the intensity of the energy intensity at this time is indicated by the color density. In addition, FIGS. 41 to 43 illustrate the energy intensity distribution in the Y position direction at the position where the X position in FIGS. 38 to 40 is 0, the horizontal axis indicates the Y position, and the vertical axis indicates the energy intensity of the laser beam.

From FIGS. 38 to 40, by shifting the laser beam direction adjustment mechanism 20a to 0.0 mm, 0.125 mm, and 4.0 mm, it was possible to confirm that the energy intensity distribution changed from uniform to non-uniform while the image shape was maintained in an annular shape by the change in color density. From FIGS. 41 to 43, with respect to the intensity ratio of the energy intensity in the front region and the rear region, when the energy intensity in the rear region was 1.0, the energy intensity in the front region was 1.0 at the time of 0.0 mm shift, whereas the energy intensity was 0.89 at the time of 0.125 mm shift and 0.14 at the time of 4.0 mm shift.

### Example 7

The optical system of the third embodiment of the energy intensity distribution adjustment mechanism illustrated in FIG. 5B was selected as the laser beam irradiation optical unit of Example 7. Here, the configuration is the same as that of Example 6 except that the laser beam direction adjustment mechanism 20b is used.

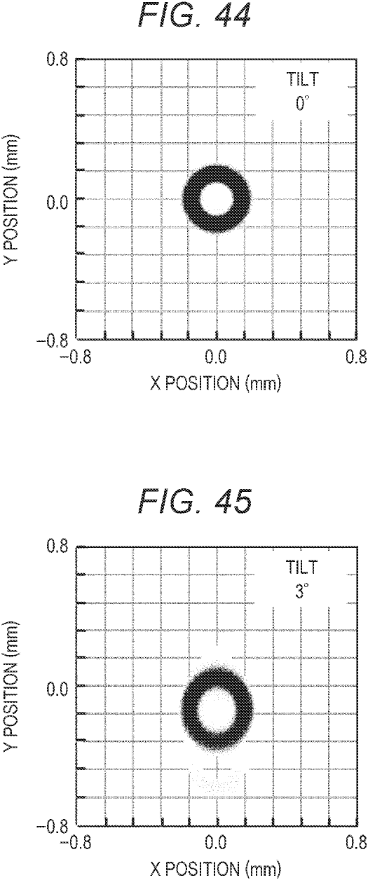

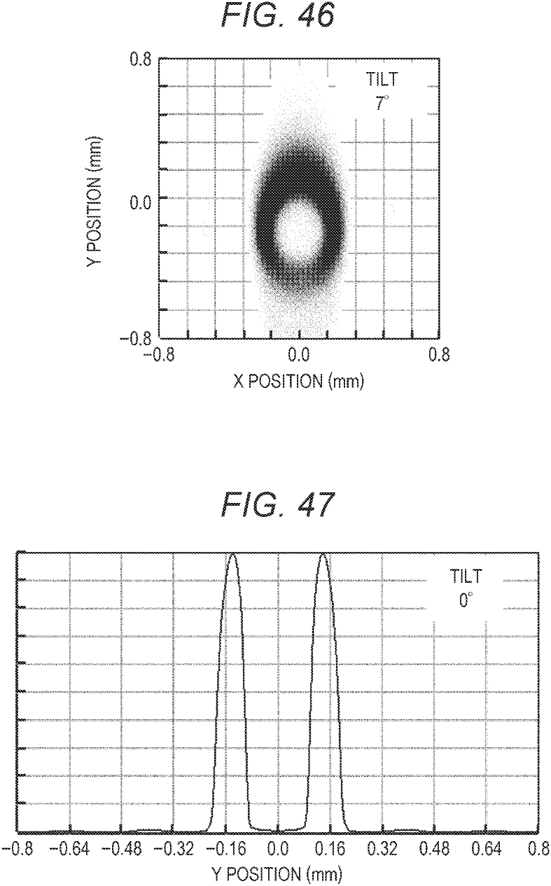

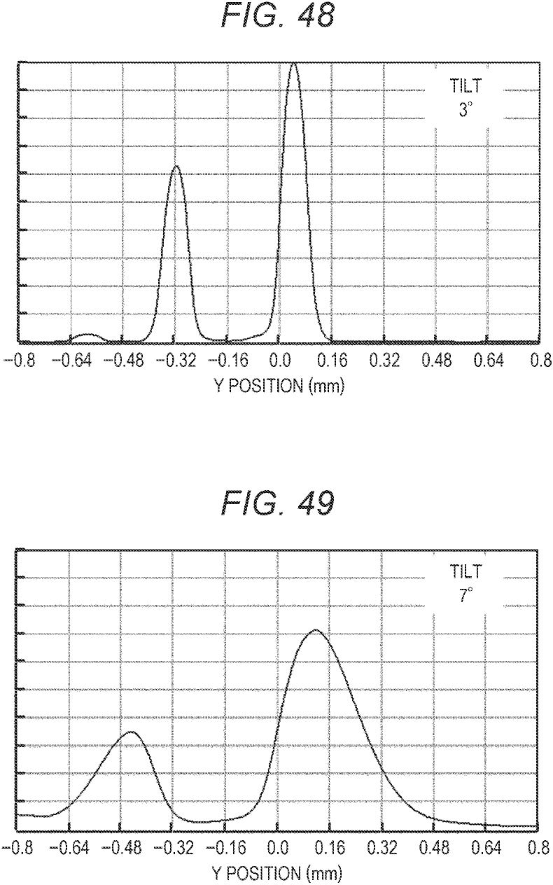

Then, the laser beam having a wavelength of 1070 nm was set to be incident on the connector unit 31 from the optical fiber 30, and simulation was performed using an optical simulator Zemax OpticStudio (Zemax, manufactured by LLc). FIGS. 44 to 49 illustrate simulation results of the energy intensity distribution in the spot when the angle of the tilt amount by the “arc-shaped turning” function of the laser beam direction adjustment mechanism 20b is 0°, 3°, and 7°. FIGS. 44 to 46 illustrate the energy distribution in the image shape of the laser beam formed on the imaging surface of the observation device 23, and the negative side at the Y position of the vertical axis corresponds to the front region during the laser machining, and the positive side corresponds to the rear region. The X position on the horizontal axis indicates coordinates orthogonal to the vertical axis. A relative ratio of the intensity of the energy intensity at this time is indicated by the color density. In addition, FIGS. 47 to 49 illustrate the energy intensity distribution in the Y position direction at the position where the X position in FIGS. 44 to 46 is 0, the horizontal axis indicates the Y position, and the vertical axis indicates the energy intensity of the laser beam.

From FIGS. 44 to 46, by setting the angles of the tilt amount by the “arc-shaped turning” function of the laser beam direction adjustment mechanism 20b to 0°, 3°, and 7°, it was possible to confirm that the energy intensity distribution changed from uniform to non-uniform while the image shape was maintained in an annular shape by the change in color density. From FIGS. 47 to 49, with respect to the intensity ratio of the energy intensity in the front region and the rear region, when the energy intensity of the rear region was 1.0, the energy intensity of the front region was 1.0 at the time of 0° tilt, whereas the energy intensity was 0.63 at the time of 3° tilt and 0.49 at the time of 7° tilt.

The laser beam irradiation optical unit according to the present invention can melt a workpiece in a front region of a spot with respect to a movement direction and appropriately blow off the metal of the workpiece melted in a rear region of the spot even when a movement speed of the spot of a laser beam is fast. This prevents the molten workpiece from remaining on a cut surface or a hole portion of the workpiece. In addition, the laser machining apparatus using the laser beam irradiation optical unit according to the present invention has a high throughput of laser machining. That is, the laser beam irradiation optical unit according to the present invention is suitable for laser machining of machining an object to be machined by irradiation with a laser beam.

What is claimed is:

1. A laser beam irradiation optical unit for forming a spot on an object to be machined and irradiating the object to be machined with a laser beam emitted from a laser oscillator to perform laser machining, the laser beam irradiation optical unit comprising:
an energy intensity distribution adjustment mechanism that adjusts an energy intensity distribution of the laser beam at the spot in an irradiation trajectory of the laser beam from the laser oscillator to the object to be machined,
wherein the energy intensity distribution adjustment mechanism adjusts the energy intensity distribution of the laser beam at the spot so as to be non-uniform.

2. The laser beam irradiation optical unit according to claim 1, wherein the non-uniform energy intensity distribution is an energy intensity distribution in which an energy intensity of the laser beam is weak in a front region that is a region on a traveling direction side of the spot on the object to be machined, and the energy intensity of the laser beam is strong in a rear region different from the front region.

3. The laser beam irradiation optical unit according to claim 1, wherein in an intensity ratio of the non-uniform energy intensity distribution, a weak energy intensity is 0.1 or more and 0.95 or less when a strong energy intensity in the energy intensity distribution is 1.

4. The laser beam irradiation optical unit according to claim 1, wherein an image shape of the laser beam at the spot is an annular shape including at least an annular peripheral region.

5. The laser beam irradiation optical unit according to claim 1, wherein the energy intensity distribution adjustment mechanism includes at least one of
a laser beam direction adjustment mechanism configured to adjust an incident direction of the laser beam on the irradiation trajectory,
a collimating lens configured to collimate the laser beam, and
a condensing lens configured to condense the laser beam on the spot.

6. The laser beam irradiation optical unit according to claim 1, further comprising an observation device configured to confirm an energy intensity distribution at the spot adjusted using the energy intensity distribution adjustment mechanism in the irradiation trajectory.

7. The laser beam irradiation optical unit according to claim 6, wherein observation light observed by the observation device is the observation light for observation different from the laser beam.

8. A laser machining apparatus obtained by accommodating the laser beam irradiation optical unit according to claim 1 in a laser machining head.
